(19) United States
(12) Patent Application Publication
(10) Pub. No.: US 2020/0299950 A1
(43) Pub. Date: Sep. 24, 2020

(54) BUILDING COMPONENTS FOR JOINING STRUCTURAL MEMEBERS

(71) Applicant: AUCKLAND UNISERVICES LIMITED, Auckland (NZ)

(72) Inventors: Pouyan ZARNANI, Auckland (NZ); Pierre Joseph Henri QUENNEVILLE, Auckland (NZ)

(73) Assignee: AUCKLAND UNISERVICES LIMITED, Auckland (NZ)

(21) Appl. No.: 16/768,568

(22) PCT Filed: Nov. 29, 2017
(86) PCT No.: PCT/IB2017/057475

§ 371 Date: May 29, 2020

(51) Int. Cl. E04B 1/26; E04H 9/02; F16B 7/04; F16B 31/02; F16F 7/12

(52) U.S. Cl. CPC E04B 1/2604; E04H 9/021; F16B 7/042; E04B 2001/2692; F16F 7/12; E04B 2001/268; F16B 31/02

(57) ABSTRACT

A connector is provided for connecting between a first and second structural members. The connector includes a load applying member which bears in use in a first direction against a crushable portion of the first structural member. A retainer retains the load applying member at an initial distance from the second structural member. A non-return mechanism can act in successive cycles of forced movement of the first structural member. When the first structural member is forcibly moved in a direction opposite the first direction the load applying member progressively crushes the crushable portion of the first structural member. When the first structural member is then moved in the first direction the retained location of the load applying member is moved in the first direction relative to the second structural member. In this way some or all of the play formed in the connection by crushing of the first structural member due to forced displacement in one direction, is taken up by the retainer during forced displacement of in the other direction. This enhances the energy absorbency of the connection during a large cyclical loading event such as an earthquake.

### FIELD OF THE INVENTION

The present invention relates to building components, and in particular to components for joining structural members in a building structure.

### BACKGROUND TO THE INVENTION

Building structures are occasionally subjected to extraordinary loads, such as during earthquakes. Structures are presently designed to cope with these loads without catastrophic failure. However, damage to the structure or parts of the structure is inevitable, and to an extent desirable or intended. In particular, predictable fracturing or plastic yielding of building components or materials can be intended to absorb energy of an event, reducing peak loads or displacements and thus lessening the risk of more significant failures.

One example of this type of predictable damage occurs in joints between wooden members and other parts of structure. Where wooden members are connected to a flange or flanges by fastener such as bolt or bolts, extreme forces can lead to crushing of wood against the fastener. This crushing can be a significant energy absorber.

However in an event, such as an earthquake, which induces cyclic forces or displacement, the wood member may be forced to move alternately relative to the fastener. Movement induced crushing in the first cycle opens up a cavity and allows a degree of “play” between the fastener and the wooden member. This play has a detrimental effect on the energy absorbency of the joint in subsequent movement cycles.

In timber buildings subjected to earthquake loadings, prior art structural joint solutions for resisting and damping seismic forces are mainly based on the yielding of the fasteners (bolts or dowels) in combination with crushing of the timber fibres by the fasteners. This achieves an amount of ductility and energy dissipation. However, earthquake loads are cyclic, with repeated loading and unloading. The fibre crushing is irreversible, so the crushed timber area does not provide an immediate response in subsequent cycles of the event. This “slack” or “play” leads to a delay in the connection response, termed “pinching”. The pinching means that the amount of energy available to resist earthquake excitation in subsequent cycles is limited.

This is illustrated in FIGS. 1 to 3. FIG. 1 shows a typical prior art connection. A first structural member 100, for example a wooden post, butts up to a second structural member 102, for example a foundation or footing. A bracket or brackets 104 are bolted to the second structural member 102, for example by bolts 106. The brackets extend along the outside of first structural member 100. Each bracket 104 includes an aperture 108. A bolt 110 passes through the apertures 108 and through a hole 112 in the first structural member 100. The bolt is secured in place by its head 114 and a nut 116.

Other example brackets include those with a single flange that fits into a slot in the end of the wooden post, and those having alternative means of securing to the second structural member, such as formations intended to anchor directly into a concrete footing or foundation.

FIGS. 2a to 2e show the manner in which the connection of FIG. 1 could be expected to respond to the cyclical loading generated in a strong earthquake.

In FIG. 2a the post 100 has been forced upward (or away from the second structural member 102, as indicated by arrow 120), bending the bolt 110 and crushing the area under the bolt 110, for example in the end regions 118. A load-slip curve for this stage of the event is illustrated by line 300 in FIG. 3a. Load is illustrated on the y-axis, and displacement on the x-axis. Load builds initially through elastic deformation of the bolt and wood, then begins to plateau as at least the wood begins to plastically yield (for example by crushing). The energy absorbed is illustrated by the shaded area 301 under this curve.

In FIG. 2b, in the next opposite phase of the load cycle, the post 100 has been forced down (or in the direction indicated by arrow 122), straightening the bolt 110. A load-slip curve for this stage of the event is illustrated by line 302 in FIG. 3b. Load reduces quickly as the elastic deformation of the bolt and wood is released. Some energy is then absorbed by the bolt as it is deformed from a bent condition back towards its initial straight condition.

In FIG. 2c, in the next cycle of the loading, the post 100 has been forced upward again, re-bending the bolt 110 and crushing the area 124 under the bolt 110, for example all the way across the width of the post. A load-slip curve for this stage of the event is illustrated by line 304 in FIG. 3c.

Load builds slowly initially through elastic and plastic deformation of the bolt only—the wood in the end regions 118 has been crushed already by the first upward movement. Once the bolt has deformed, it exerts full pressure on the wood, and the load climbs from 306 through elastic deformation of the wood until the wood begins to crush at 308. Plastic yielding continues from 308 until this upward cycle ends at 310. This has opened a substantial gap 123 behind the bolt 110. The energy absorbed is illustrated by the shaded area 312 under this curve.

In FIG. 2d the post 100 has been forced down again, releasing elastic load on the timber and bolt, and then straightening the bolt 110. A load-slip curve for this stage of the event is illustrated by line 313 in FIG. 3d. The gap 123 adjacent the bolt 110, has now been transferred to the other side of the bolt 110, showing the play that now exists in the joint. There may still be significant superficial stiffness in the joint as the plates 104 may be pressed against the sides of the structural member 100, but the play has an impact on how the joint absorbs energy in subsequent cycles.

In FIG. 2e the post 100 has been forced upward again in the direction of arrow 122, bending the bolt 110 and further crushing the area under the bolt 110, for example all the way across the width of the post. A load-slip curve for this stage of the event is illustrated by line 314 in FIG. 3e. Load does not build at all until a significant displacement is reached due to the play that has developed in the joint. The load then builds slowly from 316 initially through elastic and plastic deformation of the bolt only—the wood in the end regions 118 has been crushed already by the first upward movement. Once the bolt has deformed, it exerts full pressure on the wood, and the load climbs from 318 through elastic deformation of the wood until the wood begins to crush at 320. Plastic yielding continues from 320 until this upward cycle ends at 322. This has opened an even larger gap 126 behind the bolt 110. The energy absorbed is illustrated by the shaded area 324 under this curve.

As illustrated by these diagrams, during repeated cycles of loading the energy absorbency of the joint is progressively delayed until later in each upward displacement as the first part of the displacement takes up the play in the joint.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

It is an object of the present invention to provide a connection for structural members in a structure which will go some way toward overcoming the above disadvantages or which will at least provide the public with a useful choice.

### SUMMARY OF THE INVENTION

Accordingly the present invention may broadly be said to be a connector for connecting between a first and second structural members, the connector comprising:

a load applying member which bears in use in a first direction against a crushable portion of the first structural member,

a retainer which retains the load applying member at an initial distance from the second structural member, and

a non-return mechanism which acts in successive cycles of forced movement of the first structural member, such that when the first structural member is forcibly moved in a direction opposite the first direction the load applying member progressively crushes the crushable portion of the first structural member, and when the first structural member is then moved in the first direction the retained location of the load applying member is moved in the first direction relative to the second structural member.

Preferably the progressive crushing of the crushable portion of the first structural member occurs during its forced movement in a direction opposite the first direction due to a retention of the load applying member relative to the second structural member.

Preferably the retention of the load applying member relative to the second structural member is provided by the non-return mechanism when in an engaged condition.

Preferably the non-return mechanism allows progressive movement of the first apparatus member in a direction opposite the first direction relative to the second apparatus member during cycles of forced movement of the first apparatus member.

Preferably the non-return mechanism is configured to prevent a motion of the load applying member in a direction opposite the first direction, yet allow at least some motion of the load applying member in the first direction under cycles of movement of the first structural member.

Preferably the crushing of the crushable portion of the first structural member occurs when the first structural member is forcibly moved in a direction opposite the first direction and the non-return mechanism is in an engaged condition, and

wherein the movement of the retained location of the load applying member in the first direction relative to the second structural member occurs when the non-return mechanism is in a disengaged condition.

Preferably in the engaged condition of the non-return mechanism the load applying member is prevented from movement in the direction opposite the first direction relative to the second structural member.

Preferably the engaged condition of the non-return mechanism a binding association exists between the load applying member and the second structural member.

Preferably an operation of the non-return mechanism into its engaged condition is caused by a forced movement of the first structural member in the direction opposite the first direction.

Preferably the non-return mechanism comprises a bias to urge the non-return mechanism its engaged condition.

Preferably the bias is by a spring.

Preferably there is a biasing of the load applying member in the first direction on the crushable portion of the first structural member.

Preferably there is a biasing of the load applying member towards the second structural member.

Preferably a biasing member provides both of the bias of the non-return mechanism into its engaged condition and the bias of the load applying member towards the second structural member.

Preferably a single biasing member provides both of the bias of the non-return mechanism into its engaged condition and the bias of the load applying member towards the second structural member.

Preferably the single biasing element is a spring.

Preferably an operation of the non-return mechanism towards its disengaged condition is provided by a movement of the first structural member in the first direction relative to the second structural member.

Preferably the non-return mechanism is disengaged by a reduction below a threshold of a contact force between the load applying member and the crushable portion of the first structural member.

Preferably the reduction of the contact force comprises a reduction to a magnitude less than the magnitude of a force produced due to a biasing of the load applying member towards the second structural member.

Preferably the engagement of the non-return mechanism is by way of a frictional engagement of at least one frictional engagement member.

Preferably an increase in the force associated with the forced movement of the first structural member in the first direction results in a proportional increase in a frictional force provided by the frictional engagement assembly.

Preferably the non-return mechanism comprises a first mechanism member associated with the first structural member and a second mechanism member associated with the second structural member.

Preferably the at least one frictional engagement member comprises at least one wedge.

Preferably one of the first mechanism member and second mechanism member comprises a wedging surface to contact the at least one wedge and drive it into a frictional engagement with the other of the first mechanism member and second mechanism member, the engagement between the first and second apparatus members and the wedging element being such as to result in the locking together of the respectively associated first and second structural members.

Preferably the at least one wedge comprises at least one tooth or ridge for engaging with the other of the first mechanism member and second mechanism member.

Preferably the at least one wedge comprises a plurality of serrations for engaging with the other of the first apparatus member and second apparatus member.

Preferably at least two wedges are provided, the at least two wedges together defining a substantially conical or frustoconical body, and wherein the profile of the wedging surface substantially corresponds to the substantially conical or frustoconical body.

Preferably a bias is provided to bias the at least one wedge into engagement with the wedging surface.

Preferably the at least one frictional engagement member is pivotably associated with one of the first mechanism member and second mechanism member, the at least one frictional engagement member being pivotably biased towards engagement with the other of the first apparatus member and second apparatus member.

Preferably the frictional engagement element comprises a cam.

Preferably the cam comprises a cam profile configured such that under a movement of the first structural member in a first direction relative to the second structural member the cam is caused to frictionally engage with the other of the first mechanism member and second mechanism member, locking the first and second mechanism members and consequently also first and second structural members together.

Preferably an initial frictional engagement of the cam occurs due to the bias of the cam towards the other of the first and second mechanism member.

Preferably during a movement of the first apparatus member in a first direction relative to the second apparatus member the initial frictional engagement of the cam with the other of the first and second mechanism members results in a pivoting of the cam into further engagement with the other of the first and second apparatus member.

Preferably the cam comprises a plurality of projections or teeth for contacting the other of the first and second apparatus members.

Preferably the at least one wedge comprises a pair of cams, each cam of the pair of cams acting on opposing portions of the other of the first and second mechanism members.

Preferably the pair of cams are in the form of a cam cleat, a portion of the other of the first or second mechanism member being located between the cams of the cam cleat.

Preferably the movement of the first structural member in a first direction relative to the second structural member comprises a movement of the first and second structural members away from each other.

Preferably the movement of the first structural member in a first direction relative to the second structural member comprises a movement of the first and second structural members towards each other.

Preferably the non-return mechanism comprises the retainer.

Preferably the retainer for retaining the load applying member at an initial distance from the second structural member is provided by the function of the non-return mechanism when in an initial state.

In a further aspect the present invention may broadly be said to be a method of installing the connector as hereinbefore described, the method comprising the steps of:

a) locating the load bearing member so may bear in the first direction against a crushable portion of the first structural member,

b) connecting the first mechanism member with the first structural member,

c) associating the second mechanism member with the second structural member, and

d) removing from association with the non-return mechanism a disengagement element in order to allow the non-return mechanism to become engaged.

In a further aspect the present invention may broadly be said to be a method of servicing of a connector as hereinbefore described, when installed as part of a structure following one or more cycles of movement of the first and second structural members in the first direction and second direction relative to each other, the cycles of movement resulting in the progressive crushing of at least some of the crushable portion of the first structural member, the method comprising the steps of:

a) associating a disengagement element with the non-return mechanism to cause it to become disengaged,

b) moving the load applying member in the second direction to move it away from the crushable portion of the first structural member,

c) removing at least a crushed part of the crushable portion of the first structural member and replacing it with an un-crushed portion, and

d) removing from association with the non-return mechanism the disengagement element and returning the load applying member to bear in the first direction against the crushable portion of the first structural member.

Preferably the first structural member comprises a differentiated crushable portion, such that crushing due to the action of the load applying member acts causes crushing only or substantially only in the differentiated crushable portion.

Preferably the entire differentiated crushable portion is replaceable after crushing.

Preferably the returning of the load applying member to bearing in the first direction against the first structural member is provided by a bias of the load applying member subsequent to the removal of the disengagement element from its association with the non-return mechanism.

Preferably when the first structural member is forcibly moved in a direction opposite the first direction the non-return mechanism operates by material interference.

Preferably where the load bearing member passes through the first structural member and is supported at both ends by the retainer.

Preferably the retainer includes a first part which connects with the load bearing member, and a second part which is fixed in use to the second structural member, and the ratcheting mechanism includes a linear ratchet acting between the first and second part, which allows the retainer first part to migrate (in use), relative to the retainer second part, only in the first direction.

Preferably where the ratcheting mechanism includes a tooth or teeth on the retainer first part to act as or in a linear ratchet along the first structural member.

Preferably the tooth or teeth of the retainer first part are provided to engage directly into a surface of the first structural member.

Preferably the first part of the retainer further comprises one or more projections extending partially into the first structural member, the projections being configured to prevent or decrease sliding between the first part of the retainer and the first structural member when the first part of the retainer migrates, in use, relative to the second part of the retainer.

Preferably the retainer further comprises a third part, attached to the first structural member, the third part configured to ratchetably engage with the first part of the retainer so as to allow the retainer first part to migrate (in use), relative to the retainer third part, only in the direction opposite the first direction.

Preferably where the retainer includes a further part that is fixable to the first structural member, and the ratcheting mechanism includes a linear ratchet acting between the retainer first part and the retainer further part which allows the retainer first part to migrate (in use) along the first structural member only in the first direction.

Preferably the retainer includes a socket for receiving an end of the first structural member.

Preferably the retainer includes a flange or flanges for fixing to the second structural member.

In a further aspect the present invention may broadly be said to be a structure including a connection between a first structural member and a second structural member, the connection including a connector as hereinbefore described.

Preferably the first structural member is of wood and the crushable portion is an undifferentiated portion of the structural member.

Preferably the first structural member comprises a differentiated crushable portion, such that crushing due to the action of the load applying member acts causes crushing only or substantially only in the differentiated crushable portion.

Preferably the differentiated crushable portion is replaceable after crushing.

In a further aspect the present invention may broadly be said to be a structure including a plurality of connections having connectors as hereinbefore described.

In a further aspect the present invention may broadly be said to be a joint in a structure comprising a plurality of the connections hereinbefore described,

wherein the ratcheting mechanism of at least one of the plurality of connections is configured so as to allow a movement of the load applying member in the first direction relative to the second structural member, and

wherein the non-return mechanism of at least one of the plurality of connections is configured so as to allow a movement of the load applying member in the direction opposite the first direction relative to the second structural member.

In a further aspect the present invention may broadly be said to be a connector for connecting between a first and second structural member, the connector comprising:

a load applying member which bears in use in a first direction against a crushable portion of the first structural member, and

a non-return mechanism which retains the load applying member at a distance from the second structural member, and which acts in cycles of forced movement of the first structural member, such that when the first structural member is forcibly moved in a direction opposite the first direction the load applying member progressively crushes the crushable portion of the first structural member, and when the first structural member is then moved in the first direction the retained location of the load applying member is moved in the first direction relative to the second structural member.

In a further aspect the present invention may broadly be said to be a connector to connect a first structural member with a second structural member of or for a building or structure, the connector comprising:

a first connector member associated with the first structural member and comprising a lateral that bears in a first direction against a surface of a crushable region of said first structural member (eg it may pass into and preferably through a hole in the second structural member) and is able crush the first structural member at said surface

a second connector member associated with the second structural member and

a) wherein a non-return engagement exists between the first and second connector members, to prevent relative motion between the first and second connector members in a second direction opposite said first direction and allow progressive movement in the first direction,

b) wherein during a cycle of motion of the first or second structural member, being each of a motion in the second direction and a motion in the first direction, the lateral remains bearing against the surface in the first direction despite said region being crushed by said lateral.

Preferably the non-return engagement comprises a ratcheting engagement, the first connector member is carried by the first structural member, and the second connector member is part of or engaged with the second structural member.

In a further aspect the present invention may broadly be said to be a connector to connect a first structural member and second structural member of or for a building or structure the connector comprising:

a first connector member associated with the first structural member and comprising a lateral that bears on a surface of said first structural member in a first direction (eg preferably is passes into a hole in the first structural member) and

a second connector member part of or engaged to the second structural member and

a non-return engagement between the first and second connector members, to prevent relative motion between the first and second connector members in a second direction that is opposite said first direction and allow movement in a first direction,

a) such that a displacement of the first structural member in the second direction results in a deformation of the lateral and/or crushing of the first structural member beneath the lateral, and

b) a displacement of the first structural member in the first direction results in a ratcheting of the first and second connector members relative to each other.

Preferably the non-return engagement comprises a ratcheting engagement, the first connector member is carried by the first structural member, and the second connector member is part of or engaged with the second structural member.

In a further aspect the present invention may broadly be said to be a method of providing an anchoring or tying interaction between structural members which comprises at least a non-return progressive engagement to reduce separation responsive to external input that otherwise reciprocates the structural to cause them to separate.

In a further aspect the present invention may broadly be said to be a column or stud anchored or tied to or relative to an underlying support, at least one of the (1) column or stud and (2) underlying support being of timber; wherein the anchoring or tying provides a non-return progressive engagement interaction to reduce cycled separation.

In a further aspect the present invention may broadly be said to be a column or stud held to a footing by an interacting anchor or tie assembly able to progressively contract responsive to cycled loadings.

In a further aspect the present invention may broadly be said to be a non-return assembly for use as part of a connector between a first and second structural members, the assembly comprising:

a first assembly member for association with the first structural member,

a second assembly member for association with the second structural member, and

a wedge able to selectively engage with a wedging surface in order to frictionally engage the wedge with the second assembly member and consequently engage together the first and second assembly members upon a movement of the second assembly member in a first direction, yet allow relative movement of the first and second assembly members a movement of the second assembly in a direction opposite the first direction.

In a further aspect the present invention may broadly be said to be a non-return apparatus for use as part of a connector for connecting between a two structural members, the non-return apparatus comprising:

a first apparatus member for association with a first structural member,

a second apparatus member for association with a second structural member,

a frictional engagement assembly able to selectively engage to lock the first and second apparatus members together under a forced movement of the first apparatus member in a first direction relative to the second apparatus member, yet able to disengage and allow relative movement of the first and second apparatus members as the result of an initial forcing of the first apparatus member in a direction opposite the first direction relative to the second apparatus member.

Preferably the non-return apparatus allows progressive movement of the first apparatus member in a direction opposite the first direction relative to the second apparatus member during cycles of forced movement of the first apparatus member.

Preferably the movement of the first apparatus member in a first direction relative to the second apparatus member comprises a movement of the first and second apparatus members away from each other.

Preferably the movement of the first apparatus member in a first direction relative to the second apparatus member comprises a movement of the first and second apparatus members towards each other.

Preferably an increase in the force associated with the forced movement of the first apparatus member in the first direction results in a proportional increase in a frictional force provided by the frictional engagement assembly.

Preferably the frictional engagement assembly comprises at least one wedge associated between the first and second apparatus members.

Preferably the frictional engagement assembly is engaged by a wedging action of the at least one wedge.

Preferably the at least one wedge is biased towards a wedging condition wherein the frictional engagement assembly is engaged.

Preferably one of the first apparatus member and second apparatus members comprises a wedging surface to contact the at least one wedge and drive it into a wedging engagement with the other of the first apparatus member and second apparatus member, the engagement between the first and second apparatus members and the wedging element resulting in the locking together of the first and second apparatus members.

Preferably the at least one wedge comprises at least one tooth or ridge for engaging with the other of the first apparatus member and second apparatus member.

Preferably the at least one wedge comprises a surface having a plurality of serrations for engaging with the other of the first apparatus member and second apparatus member.

Preferably at least two wedges are provided, the at least two wedges together defining a substantially conical or frustoconical body, and wherein the profile of the wedging surface substantially corresponds to the substantially conical or frustoconical body.

Preferably a bias is provided to bias the at least one wedge into engagement with the wedging surface.

Preferably the at least one wedge comprises a frictional engagement element pivotably associated with one of the first apparatus member and second apparatus member, the cam being pivotably biased towards engagement with the other of the first apparatus member and second apparatus member.

Preferably the frictional engagement element comprises a cam.

Preferably the cam comprises a cam profile configured such that under a movement of the first apparatus member in a first direction relative to the second apparatus member the cam is caused to frictionally engage with the other of the first apparatus member and second apparatus member, locking the first and second apparatus members together.

Preferably an initial frictional engagement of the cam occurs due to the bias of the cam towards the other of the first and second apparatus member, and wherein additional frictional engagement results from the pivoting of the cam towards the other of the first and second apparatus member.

Preferably during a movement of the first apparatus member in a first direction relative to the second apparatus member the initial frictional engagement of the cam results in a pivoting of the cam into further engagement with the other of the first and second apparatus member.

Preferably the cam comprises a plurality of projections or teeth for contacting the other of the first and second apparatus members.

Preferably the at least one wedge comprises a pair of cams, each cam of the pair of cams acting on opposing portions of the other of the first and second apparatus members.

Preferably the pair of cams are in the form of a cam cleat.

In a further aspect the present invention may broadly be said to be a connector to connect a first structural member with second structural member of or for a building or structure, the connector comprising:

a first connector member of or engaged to the first structural member and

a second connector member carried by the second structural member and comprising a lateral that bears against a surface of said second structural member in a first direction (eg by passing into a hole in the second structural member),

wherein one of the first connector member and second connector member has an array of teeth and the other of the first connector member and second connector member has a pawl the pawl and teeth configured to define a ratchet between the first and second connector members, to

(A) prevent under the influence of a force acting to separate the first structural member and the second structural member in a second direction (being opposite said first direction) the separation between the first and second structural members save for any such separation resulting from the force induced deformation of at least one of:
a. the lateral (e.g. yielding), and
b. the material of the second structural member at where said lateral bears on said second structural member, caused by the lateral (e.g. crushing)

(B) allow ratcheting movement between the first and second structural members in a first direction subsequent deformation.

Preferably said deformation is of the material of said second structural member.

Preferably said deformation is of the material of said second structural member and of the lateral.

Preferably the second connector is able to translate relative said second structural member in said first direction and is restricted (preferably prevented) from translation in the second direction.

Preferably the second structural member is made of wood.

Preferably the surface to which said lateral bears is defined by a crushable material.

Preferably the crushable material is defined by an insert of said second structural member.

In a further aspect the present invention may broadly be said to be in a structure,

a first structural member,

a second structural member to bear at least some of the mass or weight of or carried by the first structural member, whether as a foundation or other, the first structural member resting directly or indirectly against or on the second structural member, and

a retainer comprising an inter-engaged first retainer portion acting on an external surface or internal surface, or both, of the second structural member, and a second retainer portion fixed to, or fixed relative to, or both, the first structural member;

wherein the inter-engagement of the first retainer portion and second retainer portion

a) allows movement of the first structural member towards the second structural member, and

b) prevents the motion of the first structural member away from the second structural member without resulting in a plastic deformation of the material of the first structural member.

Preferably the inter-engagement is a material interference type interaction.

Preferably the ratchet type interaction is more particularly a ratchet type interaction.

Preferably the inter-engagement is a friction type interaction.

Preferably the inter-engagement is of a type other than that of a ratchet type interaction.

Preferably the first structural member rests on the second structural member, which bears at least some of the weight of and/or carried by the first structural member.

Preferably at least one of the first and second structural members is of timber.

Preferably the plastic deformation of either or both of the first or second structural members is by crushing of the timber fibres.

In a further aspect the present invention may broadly be said to be a connector substantially as herein described with reference to any one or more of the figures.

In a further aspect the present invention may broadly be said to be a non-return apparatus as herein described with reference to any one or more of the figures.

The term “comprising” as used in this specification and indicative claims means “consisting at least in part of”. When interpreting each statement in this specification and indicative claims that includes the term “comprising”, features other than that or those prefaced by the term may also be present. Related terms such as “comprise” and “comprises” are to be interpreted in the same manner.

This invention may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

The invention consists in the foregoing and also envisages constructions of which the following gives examples only.

### BRIEF DESCRIPTION OF THE DRAWINGS

Preferred embodiments of the invention will be described by way of example only and with reference to the drawings.

FIG. 1 is a cross section of a joint according to the prior art.

FIGS. 2a to 2e are a sequence of cross sectional diagrams which illustrate the formation of “play” when a prior art joint undergoes a cyclical event.

FIGS. 3a to 3e are a sequence of load slip curves relating to the sequence of events illustrated in FIGS. 2a to 2e, with the shaded area in each of FIGS. 3a, 3c and 3e illustrating the energy absorbed by crushing of a portion of the structural member.

FIG. 4a is a cross sectional diagram of a joint according to one embodiment herein.

FIG. 4b is a side elevation of the joint of FIG. 4a.

FIGS. 5a to 5e are a sequence of cross sectional diagrams which illustrate how this joint is expected to behave when it undergoes a cyclical event.

FIGS. 6a to 6e are a sequence of load slip curves relating to the sequence of events illustrated in FIGS. 5a to 5e, with the shaded area in each of FIGS. 6a, 6c and 6e illustrating the energy absorbed by crushing of a portion of the structural member.

FIG. 7 is a cross sectional diagram of a joint according to another embodiment herein.

FIGS. 8a to 8d are a sequence of cross sectional diagrams which illustrate how this joint is expected to behave when it undergoes a cyclical event.

FIG. 9 is a cross sectional diagram of a joint according to another embodiment herein.

FIGS. 10a to 10d are cross sectional diagrams of a joint according to another embodiment herein, and its expected behaviour in a cyclical event.

FIG. 11 is a cross sectional diagram of a joint according to another embodiment herein.

FIGS. 12a and 12b are cross sectional diagrams of a variations on the form of a structural member.

FIGS. 13a to 13c are diagrams of structures illustrating possible locations of joints according to embodiments described herein.

FIGS. 14a to 14c are cross sectional diagrams of a combined joint according to another embodiment herein.

FIGS. 15a to 15d are cross sectional diagrams of a combined joint according to another embodiment herein.

FIG. 16 is a cross sectional diagram of a joint according to another embodiment herein.

FIGS. 17 and 18 are front and side views of a joint or connector, when connected to two structural members, according to another embodiment.

FIGS. 19a-e show further detail of the connector of FIGS. 17 and 18 including a non-return mechanism of the connector.

FIGS. 20a-c show the operation of the non-return mechanism of the connector of FIGS. 17 and 18.

FIGS. 21a-b show further detail of the configuration of FIGS. 17 and 18.

FIG. 22a is a cross sectional diagram which illustrates how this connector is expected to behave when the first structural member undergoes a forced movement in the second direction as part of a cyclical event.

FIG. 22b is a load slip curve relating to the event illustrated in FIG. 22a.

FIG. 22c is a load slip curve relating to the event is illustrated in FIG. 22a, with the shaded area illustrating the energy absorbed by the crushing of a portion of the structural member.

FIG. 23a is a cross sectional diagram which illustrates how this connector is expected to behave subsequent to the event of FIG. 22a, when the first structural member is allowed to return in the first direction as part of a cyclical event.

FIG. 23b is a load slip curve relating to the event illustrated in FIG. 23a.

FIG. 23c is a load slip curve relating to the event is illustrated in FIG. 23a, showing negligible or no useful energy being absorbed by this event.

FIG. 24a is a cross sectional diagram which illustrates how this connector is expected to behave subsequent to the event of FIG. 23a when the first structural member is again forced in the second direction as part of a cyclical event.

FIG. 24b is a load slip curve relating to the event illustrated in FIG. 24a.

FIG. 24c is a load slip curve relating to the event is illustrated in FIG. 24a, with the shaded area illustrating the energy absorbed by the crushing of a portion of the structural member.

FIG. 25a is a cross sectional diagram which illustrates how this connector is expected to behave subsequent to the event of FIG. 24a when the first structural member is allowed to return in the first direction as part of a cyclical event.

FIG. 25b is a load slip curve relating to the event illustrated in FIG. 25a.

FIG. 25c is a load slip curve relating to the event is illustrated in FIG. 25a, with the shaded area illustrating the energy absorbed by the crushing of a portion of the structural member.

FIG. 26a-c show further details of a connector.

FIGS. 27a-c show a steps in a process of installing a connector.

FIG. 28a-b show another application of the connector of FIGS. 17 and 18.

FIG. 29 shows a further embodiment of a connector.

FIG. 30 shows a further embodiment of a connector.

### DETAILED DESCRIPTION OF PREFERRED EMBODIMENTS

The present invention relates to joining of structural members to other structural members in a building or structure. The structural members might be, for example a post, beam, joist, rafter, brace, wall or panel, or a foundation or footing. For the purposes of the present invention one of the structural members is of a material that can yield plastically under excessive force, for example by crushing or by tearing of fibres, to absorb significant amounts of energy. For example the member may be formed from wood, or a portion of the member at the location of the joint may be formed from wood, or from an energy absorbing crushable material such as a manufactured composite honeycomb or foam material.

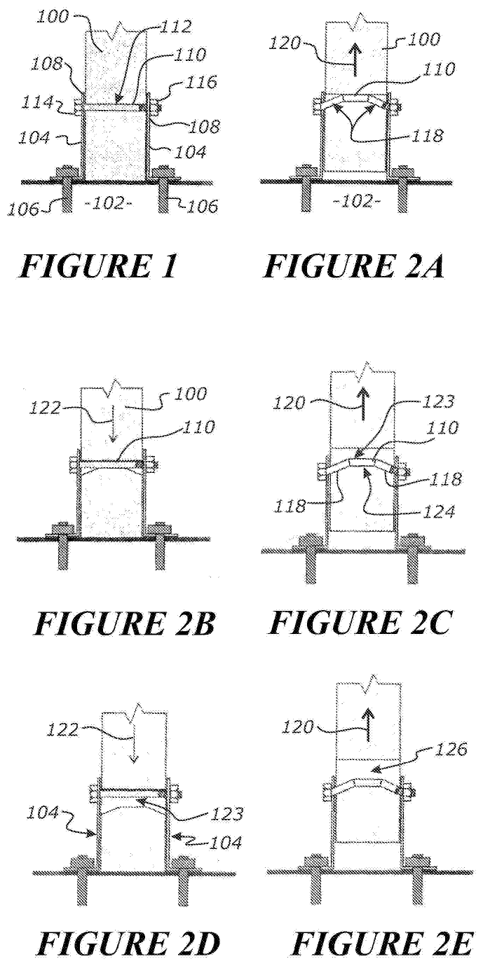

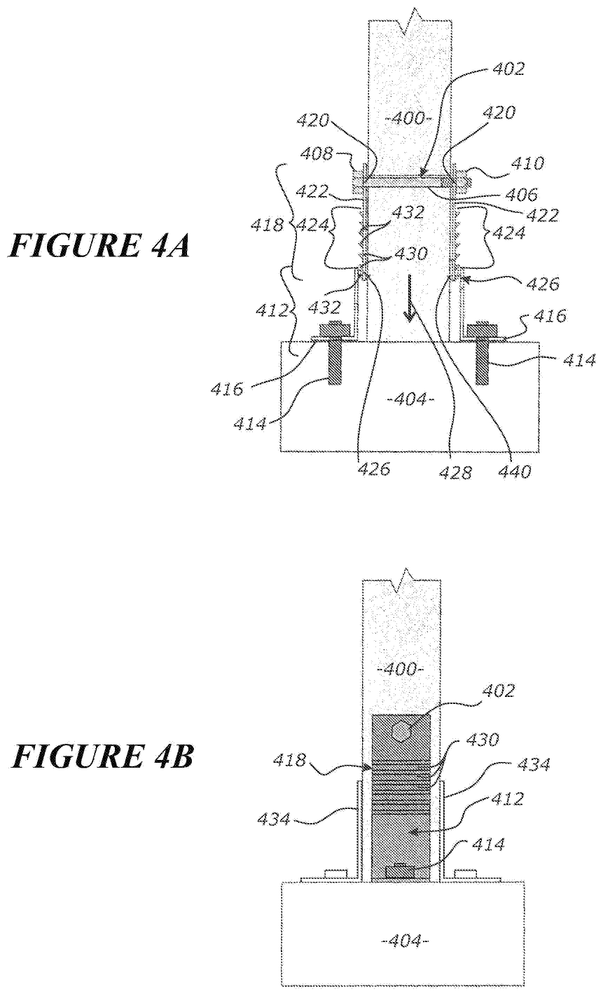

An embodiment of joint which is believed to exhibit improved behaviour over the prior art joint of FIGS. 1-3 is illustrated by way of example in FIGS. 4a and 4b.

In the joint of FIGS. 4a and 4b, a load bearing member 402 is supported by a retainer 450 at an initial location spaced from the second structural member 404. The retainer 450 comprises multiple parts which interact to provide a non-return effect in relation to the retained position of the load bearing member 402. According to this non-return effect the position of the load bearing member 402 is restrained by the retainer from moving away from the second structural member 404 (for example while the first structural member is being forcibly moved away from the second structural member), but can be forced toward the second structural member (for example while the first structural member is being forcibly moved toward the second structural member), to adopt a new position where it is retained closer to the second structural member.

In the joint of FIGS. 4a and 4b, the non-return effect is more specifically a ratchet effect.

The load bearing member 402 may be a bolt or other member that passes into or through the first structural member 400. For example, in the embodiment illustrated in FIG. 4a the load bearing member is the shank of a bolt 406 secured in place by its head 408 and nut 410.

Alternatively, the load bearing member may be a flange or other feature providing a surface to bear appropriately against the first structural member. For example FIG. 11 illustrates an embodiment which is generally similar to FIGS. 4a and 4b, except that the load bearing member comprises a flange 1100 which engages a ledge 1102 in the side face of the structural member 1104. The flange does not pass through the structural member, but still bears against it in a direction to restrain the structural member in the desired manner.

In the embodiment of FIGS. 4a and 4b the retainer 450 can be seen as being two parts, although each part may in fact involve more parts assembled or contributing to the whole.

The retainer includes a first part 412 that is secured to the second structural member.

In the illustrated form the first part 412 may be secured by bolts 414 through flanges 416. However, other arrangements for securing the retainer to the second structural member may be adopted, for example alternative plates or flanges, or formations for directly embedding in a foundation or footing, as previously described with reference to the prior art.

The retainer includes a second part 418 that connects with, and retains the position of, the load bearing member 402.

In the illustrated form this is by apertures 420 through the side plates 422 forming the second part.

Interaction between features of the first part 412 and the second part 418 contribute to the ratcheting effect. One part includes a series of ledges, teeth or detents, for example 424. The other part includes an effective pawl 426 which is urged into engagement with the detents 424, to engage in a detent. The pawl and or series of teeth include ramped surface or surfaces 430 to facilitate disengagement and sliding over one another in one direction of movement, and butting surfaces 432 to engage against one another in the opposite direction of movement. According to the embodiment of FIGS. 4a and 4b, advancement of the second part 418 relative to the first part 412 is possible in the direction of arrow 428, but retraction in the opposite direction is prevented; at the initial position, and in subsequent advanced positions.

According to alternative embodiments, the advancement of the second part 418 may relative to the first part 412 may be prevented in the direction of arrow 428, but retraction in the opposite direction is allowed; at the initial position, and in subsequent advanced positions also.

In the illustrated embodiment, urging of the pawl of one part into engagement with the teeth of the other part is by the elasticity of brackets of first part 412. In particular, the brackets are separated sufficiently for the second part (or the structural member) to pass between them, but close enough for the pawl forming lips to engage the detents of the second part. For the second part to advance relative to the first part the brackets of the first part 412 flex outward, forced apart by the ramped surfaces. This could alternatively be achieved in other ways. For example the pawl could be provided as a hinging component linked to the brackets and biased into engagement by a spring or springs, so long as the strength of the combination is sufficient. The illustrated embodiment has a simplicity that is desirable.

The side plates of the second part 418 are engaged against the outside of the post. In this embodiment the side plates, and the consequently the second part 418, are able to move along the post in a direction toward the second structural member during forced movement of the post 400 in a direction away from the second structural member 404. However the plates are retained in this new position with sufficient strength to overcome resistance from the ratchet interaction of the first and second parts during a return movement of the post 400 toward the first structural member 404. This may be achieved in part or in whole by sufficient tightening of the securing bolt, so that friction of the plates against the sides of the post alone is sufficient.

Alternatively, and as illustrated in the FIG. 4 embodiment, the side plates of the retainer may have protruding bards to engage in the surface of the first structural member and provide substantial resistance to relative movement of the side plates along the first structural member in one direction (in the illustrated arrangement the direction away from the second structural member), while generally allowing relative movement in the opposite direction.

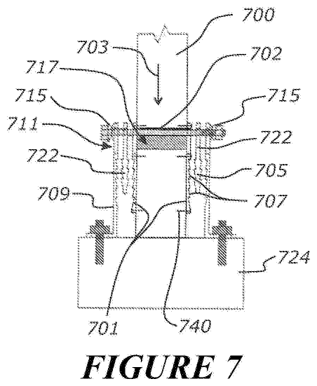

In another alternative, a ratcheting arrangement may be provided between the retainer and the first structural member, including specific formations formed on or attached to the first structural member, to interact with specific formations formed on or attached to the retainer. An example of this is described later with reference to FIG. 7.

The connection has been described primarily with reference to the cross section of FIG. 4a. This serves to illustrate the main parts of the connection and the arrangement that implements the desired ratcheting effect. FIG. 4b (in conjunction with FIG. 4a) illustrates that the first part of the connection may be implemented by a pair of brackets interacting respectively with each of a pair of plates implementing the second part. One of each pair are located on each side of the first structural member 400. In this configuration some additional lateral support may be desirable for the butt of the member 400. For example additional brackets 434 could be provided to constrain lateral movement, without being connected or joined to the member 400. Similar constraining structures may be integrated with the first part 412, and may serve to join the two brackets of the first part 412 into a single unit. Alternatively the two brackets of first part 412 may be joined by a plate passing under the butt end of member 400.

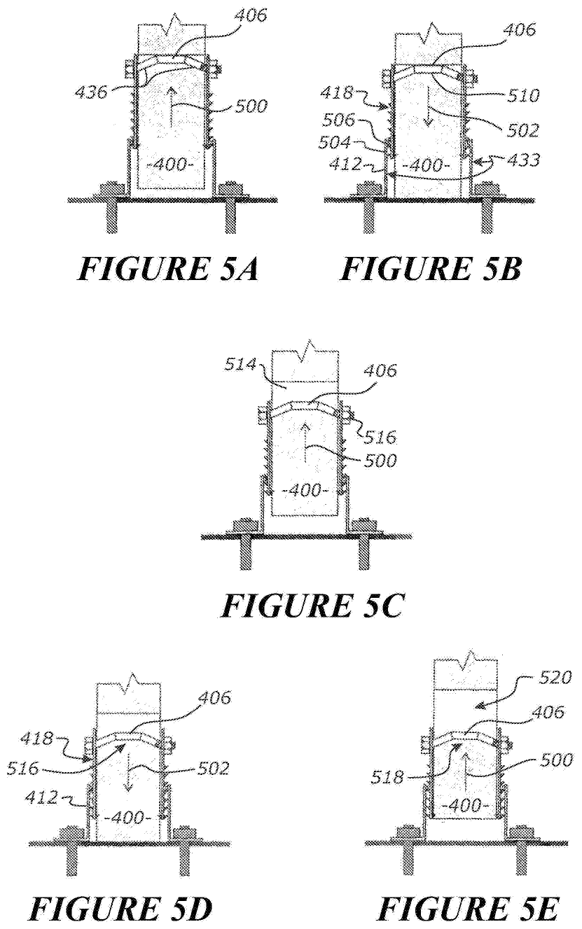

FIGS. 5a to 5e show the manner in which the connection of FIG. 4 could be expected to respond to the cyclical loading generated in a strong earthquake.

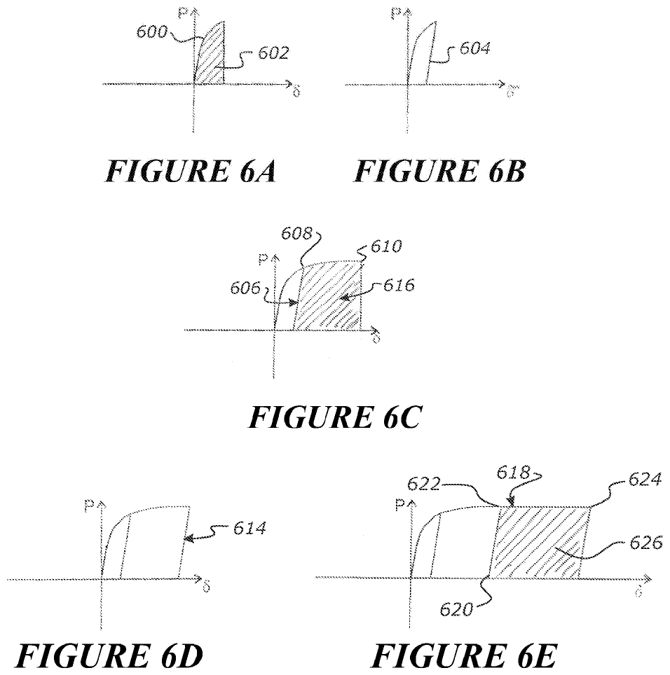

In FIG. 5a the post 400 has been forced in the direction of arrow 500. This may cause bending the bolt 406, such forced movement crushing the area under the bolt 406, for example in the end regions 436. A load-slip curve for this stage of the event is illustrated by line 600 in FIG. 6a. Load is illustrated on the y-axis, and displacement on the x-axis. Load builds initially through elastic deformation of the bolt and wood, then begins to plateau as at least the wood begins to plastically yield (for example by crushing). The energy absorbed is illustrated by the shaded area 602 under this curve.

In FIG. 5b the post 400 has been forced in the direction of arrow 502. This results in the second part 418 of the retainer being forced down relative to the first part 412 of the retainer. The brackets 438 of the first part have been elastically splayed open by the ramped portion of the tooth on the exterior of the second part, and allowed the tooth 504 to pass the pawl 506 of the first part. The brackets 438 have then returned to engage the pawl 506 behind the tooth 504. The bolt 406 has not been straightened, and remains bent. A load-slip curve for this stage of the event is illustrated by line 604 in FIG. 6b. Load reduces quickly as the elastic deformation of the bolt and wood is released.

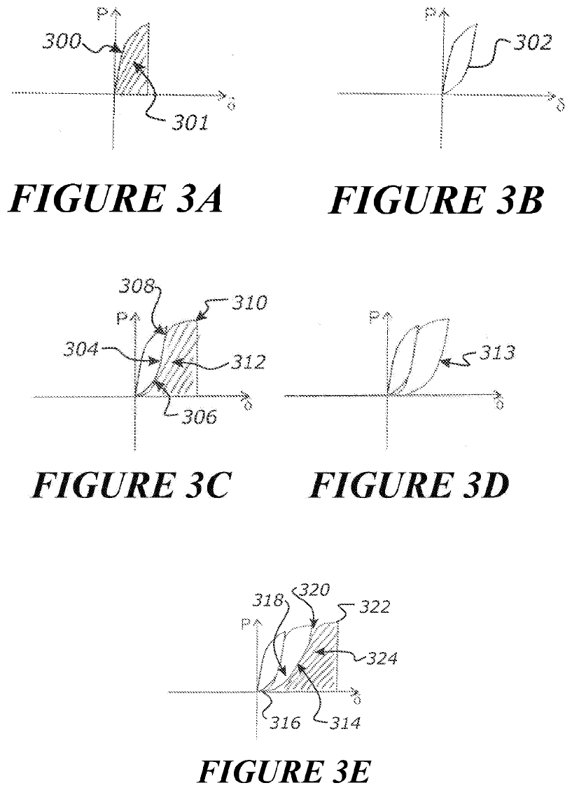

In FIG. 5c the post 400 has been forced in the direction of arrow 500 again. The bolt 406 is already against the crushed surfaces 510 of the aperture through the post. All displacement of the post results in further crushing 516 of the post material. A load-slip curve for this stage of the event is illustrated by line 606 in FIG. 6c. Load builds rapidly through elastic deformation of the wood and bolt until the wood begins to crush at 608. Plastic yielding continues from 308 until this upward cycle ends at 610. This has opened a substantial gap 514 behind the bolt 406. The energy absorbed is illustrated by the shaded area 616 under this curve. This absorbed energy is substantially greater than in the equivalent shaded area in FIG. 3c for the prior art example.

In FIG. 5d the post 100 has been forced in the direction of arrow 502 again, releasing elastic load on the timber, and driving the second part 418 of the retainer into deeper engagement with the first part 412 of the retainer. A load-slip curve for this stage of the event is illustrated by line 614 in FIG. 6d. In contrast to the situation illustrated in FIG. 2d the bolt remains substantially adjacent the crushed material 516 of the structural member.

In FIG. 5e the post 100 has been forced in the direction of arrow 500 again, further crushing the area 518 under the bolt 406, for example all the way across the width of the post. A load-slip curve for this stage of the event is illustrated by line 618 in FIG. 6e. The load climbs immediately from 620 through elastic deformation of the wood until the wood begins to crush at 622. Plastic yielding continues from 622 until this upward cycle ends at 624. This has opened an even larger gap 520 behind the bolt 110. The energy absorbed is illustrated by the shaded area 626 under this curve. This absorbed energy is substantially greater than that illustrated in FIG. 3e.

As illustrated by these diagrams, during repeated cycles of loading the energy absorbency of the joint is similar in each upward displacement. The play that develops in the joint in each upward displacement is taken up by the ratcheting effect in the retainer during each following downward displacement. Thus in a sequence of cycles the proposed joint is expected to absorb substantially more energy than the prior art joint.

Another embodiment of joint is illustrated in FIG. 7. It is to be noted that the parts are shown with gaps between for clarity. This is diagrammatic license—in the connection the different plates and brackets will be arranged and secured without any substantial gaps between, so that teeth which implement the ratchet arrangements are retained in an interfering relationship.

This joint involves a connector having substantial similarity to the connector of FIGS. 4a and 4b, and the same overall principles apply. Accordingly the connector, and its operation, will be described principally in relation to the differences from the embodiment of FIG. 4.

In the connector of FIG. 7 the side plates 722 of the retainer do not bear directly against the side surfaces of the structural member 700. Instead the side plates engage with fascia plates 701, which are secured in position on the side faces of the structural member 700.

The fascia plates 701 may be secured to member 700 by any suitable means, for example by adhesive or by mechanical fasteners.

The fascia plates may extend along the member 700 including in the region of the hole that receives the load bearing member 702, in which case the fascia plate includes an opening in the location of the hole, preferably a slotted opening with the slot arranged to accommodate intended potential future positions of the load bearing member as the hole itself becomes slotted due to crushing.

Alternatively the fascia plates may be provided only to one or other side of this location—for example only closer to the butt end of the member 400.

The side plates 722 and the fascia plates 701 are provided with features to engage in use in a manner that produces a linear ratchet effect between the side plates 722 and the fascia plates 701. This ratchet effect is to allow the side plates 722 of the retainer to advance in the direction of arrow 703 relative to the structural member 700, but not to return in the opposite direction. This is an alternative to the barbs of the side plates of FIG. 4, which engage directly with the wooden member 400.

For example, in the illustrated embodiment the side plate is provided with one or more teeth 705 that act as multiple pawls to engage in a more extensive series of teeth 707 on the fascia plate. The more extensive series of teeth may alternatively be provided on the side plate, or both plates may have the same number of teeth. Alternatively other features—for example teeth, lugs, tangs detents—may be provided to achieve the ratchet effect. Alternatively the ratchet affect may be manifested by features of the side plate and fascia plate acting in conjunction with one or more intermediate additional components.

Otherwise the side plates incorporate additional tooth or teeth facing away from the structural member, to engage with tooth or teeth facing inward from brackets 709. As before, this implements a ratchet which will only allow the side plates to progressively move in the direction of arrow 703 relative to the second structural member.

These arrangements of teeth also serve to illustrate an alternative set of surface features that can implement a ratchet when compared with the single pawl of the embodiment of FIG. 4. In effect the side plates of FIG. 7 have a series of pawls facing from each side, to engage at the same time with multiple teeth of adjacent fascia plate and bracket.

A further element that is illustrated in the embodiment of FIG. 7 is an upward extension of the brackets 709 to overlap the location of the load bearing member 702. The brackets 709 include slotted holes 711. The load bearing member passes through the slotted holes. The load bearing member may be used to exert an inward pressure on the brackets. This may be created, where for example the load bearing member is a bolt, by suitable tightening of the nut. To allow for certain flexing of the brackets and facilitate ratcheting of the two parts of the retainer, spring washers 715 may be provided between the head of the bolt and the bracket or between the nut of the bolt and the bracket or both.

A further variation included in the embodiment illustrated in FIG. 7 is the provision of a distinct, crushable insert 717 in the structural member 700. The crushable insert may be, for example, a composite material intended to absorb significant energy through crushing or crumpling. The insert is provided within the hole through the member 700, to lie between the load bearing member 702 and the second structural member. In this way and energy absorbing joint may be provided in structural members of materials that do not normally exhibit this crushing behavior. Or, such inserts may be provided into joints that are serviced after an event has resulted in crushing of the original material. Such inserts would become crushed during an event, but then may be replaced after an event in order to restore the connection to its original, or any other desired, condition.

Such a variation with the crushable insert 717 is not limited to the embodiment illustrated in FIG. 7, but may be provided in any of the embodiments described herein.

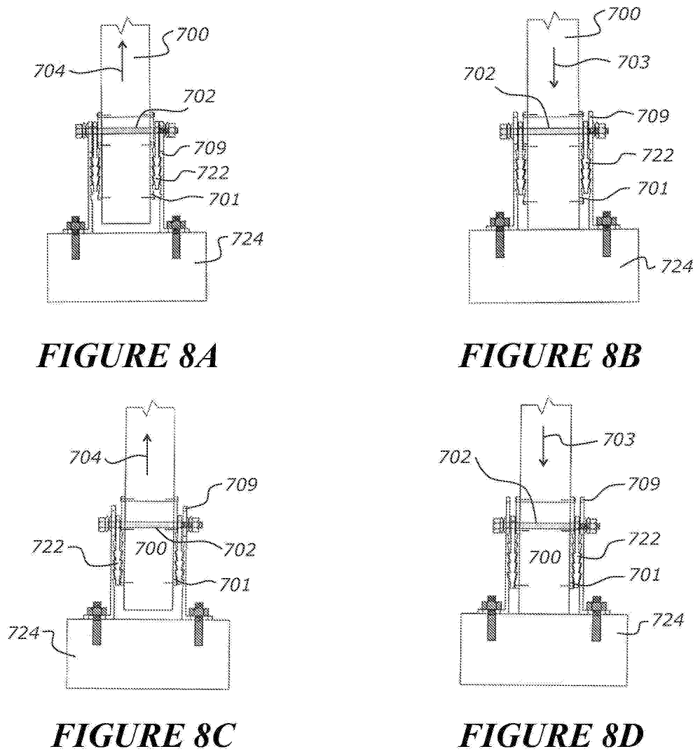

Expected behaviour of the connector embodiment of FIG. 7 is illustrated by the sequence of diagrams 8A to 8D. In FIG. 8A the post or first structural member 700 has been forced in the direction of the arrow 704, being a direction away from the second structural member 724. This movement may be sufficient to bend the load bearing member 702, or as shown in the configuration of FIG. 8A the load bearing member provided may be such that no plastic deformation of the member takes place. The movement of the post for first structural member 700 relative to the second structural member 724 and load bearing member 702 results in the crushing of the area under the load bearing member.

The load slip curve for this event is similar to that indicated by the line 600 in FIG. 6A.

In FIG. 8B the post 700 has been forced in the direction of arrow 703. This results in the load bearing member 702 and side plates 722 of the retainer being forced down relative to the first part or brackets 709 of the retainer.

The brackets 709 have been elastically splayed open by the ramped portion of the teeth 705 of each side plate 722, allowing the one or more teeth 705 of the brackets 709, which act as multiple pawls, to pass the series of teeth 707 on either or both of the fascia plates 701 and brackets 709.

In FIG. 8C the post or first structural member 700 has again been forced in the direction of arrow 704. The configuration teeth and pawls of the fascia plates, brackets and side plates prevent the movement of the side plates and load bearing member in the direction of arrow 704. This means that the motion of the first structural member in the direction of arrow 704 results in further crushing of the material of the first structural member 700 beneath the load bearing member 702.

In FIG. 8D the first structural member 700 has been forced in the direction of arrow 703 again, driving the side plates 722 into deeper engagement with the teeth or pawls of either or both of the fascia plates 701 and brackets 709.

As described in relation to FIG. 5, during the motion described in relation to FIGS. 8A to 8D the load bearing member 702 remains substantially adjacent the crushed material of the first structural member 700.

The load slip characteristics of the events shown in FIGS. 8B to 8D are expected to be substantially similar to those shown in FIG. 6B to 6D.

Where the load bearing member 702 is provided as a substantially rigid member such that it does not undergo plastic deformation during the events of FIG. 8A to 8D, the initial characteristics will differ from those shown in FIG. 6A. Rather than the curve 600 of FIG. 6A, reflecting the plastic deformation of the load bearing member, the load will increase quickly until the point at which crushing begins, in a way similar to what is shown by line 606 of FIG. 6C.

In all the embodiments described herein the ability of the connector to absorb energy during repeated cycles of loading will be limited by the amount of ratcheting available between parts of the retainer, or in some embodiments by the amount of ratcheting sufficient to cause that the first part 412 of the retainer or the side plates 722 to come into contact with the second part of the retainer 418, second structural member, or any other element.

It is contemplated that the size and configuration of the connector, including the degree of ratcheting available, may be configured to suit the desired application and the amount of energy absorbency desired. Further, the sizing of the tooth or teeth and pawl or pawls of the retainer may be sized to suit the particular application.

In addition, the amount of displacement required to move to the next ratcheting position, defined by the length of tooth and pawl surfaces, may be varied to suit the application. For example, where small cycles of displacement are expected, the tooth and pawl dimensions may be decreased so as to give a finer resolution between respective positions of the retainer components.

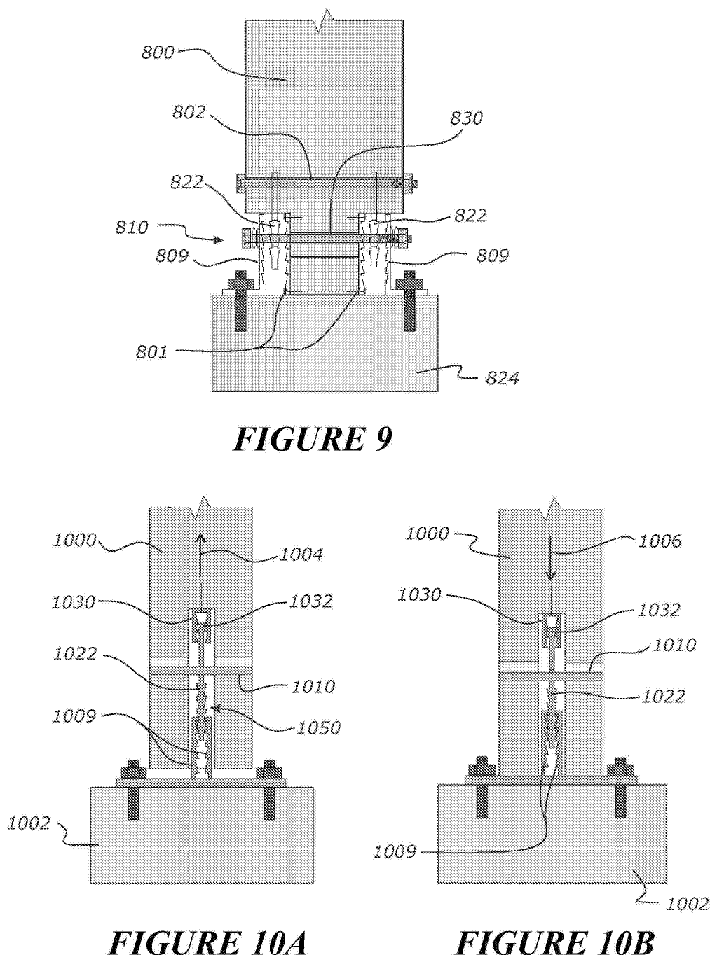

A further embodiment is shown in FIG. 9. The connector illustrated in FIG. 9 is substantially similar to that of the embodiment of FIG. 7, except that the retainer is configured to lie within the lateral dimensions of the upper portion of the first structural member or post 800.

In this embodiment the first structural member 800 is modified to have cut-outs 810 extending inwardly of the full lateral dimension of the post, at the portion of the post towards the second structural member 824. As seen in FIG. 9 the fascia plates 801, side plates 822 and brackets 809 all lie within the cut-outs 810 of the post 800.

In order to facilitate the configuration of FIG. 9, the side plates 822 may extend upwardly through a portion of the post 800 before the point at which they are connected with the load bearing member 802. This is seen in FIG. 9.

The configuration of FIG. 9 may be desirable where it is desirable to have a structural connection with the energy absorbency characteristics of the present invention, but where the total width of the joint is not desired to exceed that of the post 800. This may for example be the configuration in some walls, where it is desirable to present an at least substantially continuous external surface, for example for aesthetics or in order to facilitate covering with wallboards or other substantially planar coverings.

In any of the embodiments herein described a fixing member 830 may be provided across or through the retainer in order to hold the respective tooth or teeth in engagement with the pawl or pawls, to prevent the motion of the first and second part of the retainer away from each other.

Such a fixing member 830 is shown in FIG. 9. The fixing member 813 shown passes through the retainer elements and through the first structural member 800. In order to allow for ratcheting movement of the joint, where the fixing member 830 is provided the side plates 722 may be provided with a slot to accommodate the fixing member 830 at a range of ratcheted positions.

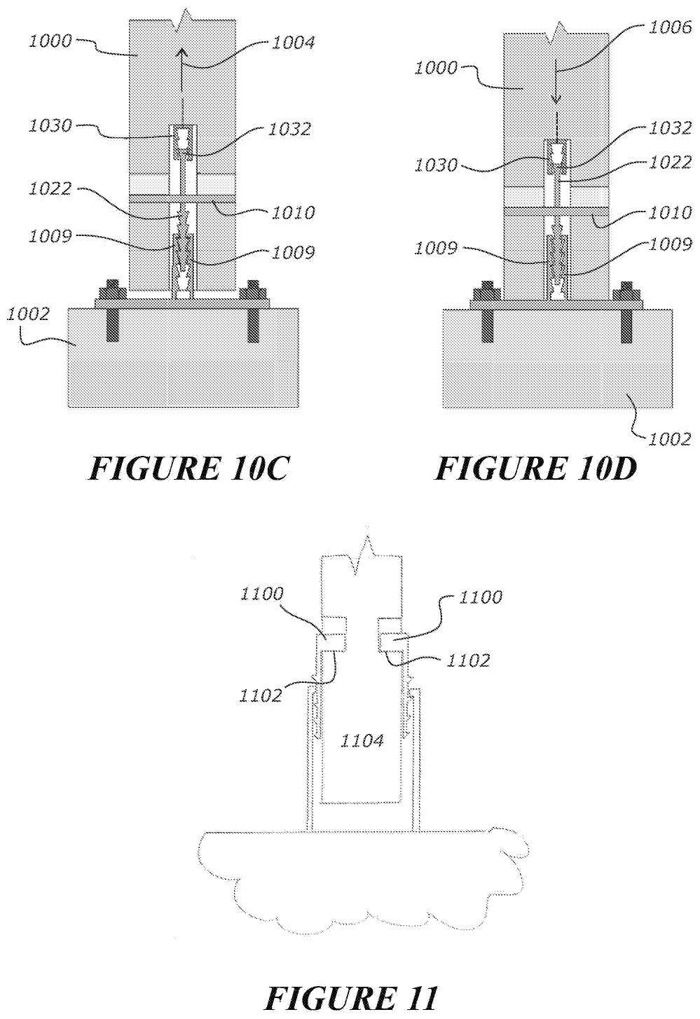

A further alternate embodiment is shown in FIGS. 10A to 10C. This embodiment has primarily the same features and same method of operation as described in relation to the earlier embodiments.

In FIG. 10A there is a first structural component or post 1000 and second structural component 1002. A load bearing member 1010 passes through the first structural member. The load bearing member 1010 may pass entirely though the first structural member, as shown in FIG. 10A, or may not extend to the full width of the first structural member. This configuration may be desirable to prevent the crushing of material at the external surfaces of the first structural member.

Either integral with or connecting to the load bearing member 1010 is the first component 1022 of the retainer. The first component 1022 engages with the second component 1009 of the retainer. The second component 1009 is preferably fixably attached or integral with the second structural member 1002.

As seen in FIG. 10A, the first and second components of the retainer are provided substantially within a slot 1050 within the first structural member 1000. By this configuration, and particularly also where the load bearing member 1010 is provided such that it does not extend to or past the lateral dimensions of the first structural member 1000, a connector between the first and second structural members may be provided which sits fully within the existing dimensions of the two structural members.

The engagement between the first component 1022 and second component 1009 of the retainer, and their ratcheting operation relative to each other, are substantially as previously described. In addition to this previously described engagement, the first component 1022 is also engaged with third component 1030. The third component is preferably fixably engaged to the first structural member 1000.

Either of the first component and third component are provided with a respective tooth or teeth and pawl or pawls, such that the components are able to rachetably move relative to each other in one direction, but are prevented from moving relative to each other in an opposite direction.

The configuration of the tooth or teeth and pawl or pawls of the first component 1022 and third component 1030 is preferably the opposite of that between the first component 1022 and second component 1009. In this manner the first and second components may move relative to each other in a second direction, but be resisted in a first direction, while the first and third components are resisted moving relative to each other in the second direction but are able to move relative to each other in the first direction.

The engagement between the first component 1022 and third component 1030 is preferably such that under the movement of the first structural member in the direction of arrow 1006 that the first component 1022 is forced downwards substantially with the first structural member, and is forced into deeper engagement with the second component 1009. The engagement between the first component and third component limits or prevents separation between the load bearing member 1010 and the crushed or crushable surface of the first structural member 1000.

As shown in FIG. 10A the first structural member 1000 has been forced in the direction of arrow 1004. The engagement between the first component 1022 and second component 1009 acts to retain the load bearing member relative to the second structural member, resulting in a crushing of the material of the first structural member beneath the load bearing member 1010. The crushing of the material of the first structural member results in energy absorption as previously described.

At the same time, the engagement between the first component 1022 and third component 1030 of the retainer allows relative motion between the two components, resulting in sliding of the tooth or teeth and pawl or pawls of the components over each other and an advancement of their position relative to each other.

As seen in FIG. 10B the first structural member is forced in the direction of arrow 1006. The engagement between the first component 1022 and third component 1030 resists relative motion between the components. This causes the movement of the first structural member to drive the first component of 1022 of the retainer towards the second component 1009 of the retainer. The ratcheting nature of the first and second components, as previously described, results in an advancement of the position of the first component 1022 of the retainer with respect to its second component 1009, such that the slack in the connection is substantially taken up.

Upon a successive cycle of motion in the direction of the arrow 1004 as shown in FIG. 10C, the connector continues to crush the material of the first structural member beneath the load bearing member 1010. Successive movements in the direction of arrow 1006 of FIG. 10D result in further ratcheting of the components of the retainer relative to each other. This cycling of motion may continue, absorbing energy, until all the first and second components cannot ratchet any further relative to each other, or the entirety of the material to be crushed has been exhausted.

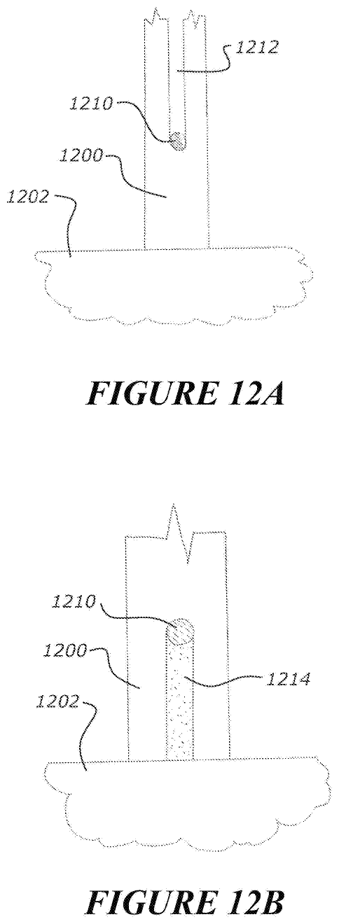

FIG. 12A shows a variation of the connector as previously described wherein the first structural member 1200 is provided with a slot 1212 above the load bearing member 1210. Such a slot may extend fully through the lateral dimension of the first structural member, or may extend only partially through such. It is contemplated that such a configuration with a slot 1212 may provide advantages for the assembly or maintenance of the connector.

As previously described in relation to FIG. 7, a crushable insert 717 may be provided in the structural member 700. A further configuration of such a crushable member 1214 as part of the first structural member 1200 is shown in FIG. 12B.

The crushable member 1214 may be provided as a removable or replaceable insert in the first structural member 1200. The crushable insert 1214 may be provided of the same, similar, or different material than that of the first structural member, in order to achieve desired crushing and energy absorbency characteristics.

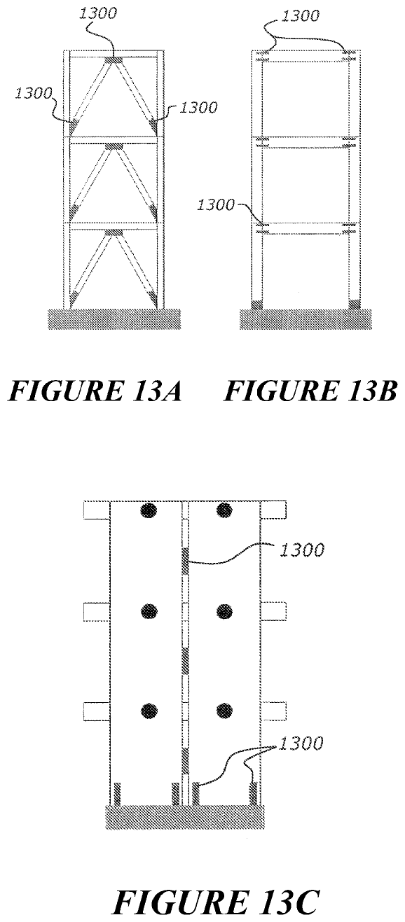

A number of contemplated potential applications of the connector herein described are shown FIGS. 13A to 13C. The connectors, indicated by 1300, may be located at a variety of different locations and in a variety of configurations in any common structural applications. This includes any shear wall applications, as seen in FIG. 13C, or other structural framing and jointing configurations shown in FIGS. 13A and 13B.

Though not shown in all embodiments it is contemplated that the connector may likely require some form friction or engagement or attachment between the first structural member and either or both of the first component of the retainer and load bearing member.

This engagement would ensure that the load bearing member remains substantially against or proximate to the surface of the crushed material of the first structural member during portion of cycling of the connector where the retainer portions ratchet relative to each other.

This engagement is necessary to overcome the frictional and contact forces associated with the relative motion of the tooth or teeth and pawl or pawls of the first and second portions of the retainer. This may include the frictional forces of the tooth or teeth and pawl or pawls sliding over each other, and the contact and deformation forces associated with any lateral bending of the first part or bracket of the retainer.

This engagement may be provided by sufficient frictional engagement between the portion of the retainer adjacent to the first structural member and the first structural member itself. In such a configuration this frictional engagement would act to provide additional damping during the crushing portion of the movement cycle of the connector.

Alternatively, as seen in FIG. 4A the retainer may comprise a barb 440 or other contact element to engage with the surface of the first structural member. The barbs 440 will move relative to the first structural member during the crushing portion of the movement cycle, but engage with the first structural member to prevent relative motion between the second component of the retainer and the first structural member during the ratcheting portion of the cycle.

The barbs 440 seen in FIG. 4A may additionally be configured to substantially allow motion between the first structural member and barbs during the crushing component of the connector's cycle, but prevent any relative motion between the two parts during the return portion of the cycle. Such a functionality may be provided by upwardly angled barbs, as shown in FIG. 4A, or may also be provided by barb members flexible in one direction, but substantially rigid in the other.

In the configuration of FIGS. 7 and 8, where fascia plates 701 are provided adjacent the first structural member 700 and do not move relative to it, fastening members 740 may be provided to directly fix the fascia plates to the first structural member. As there is no relative movement between the first structural member 700 and fascia plates 701 during the cycling of displacement of the first structural member, the fastening members 740 need not accommodate motion in one direction and prevent motion in the other direction, as previously described in relation to the embodiment of FIGS. 4 and 5. Accordingly, the fastening members 740 may be in the form of nails, pins or other fixings, or may alternatively be provided by some permanent adhesive.

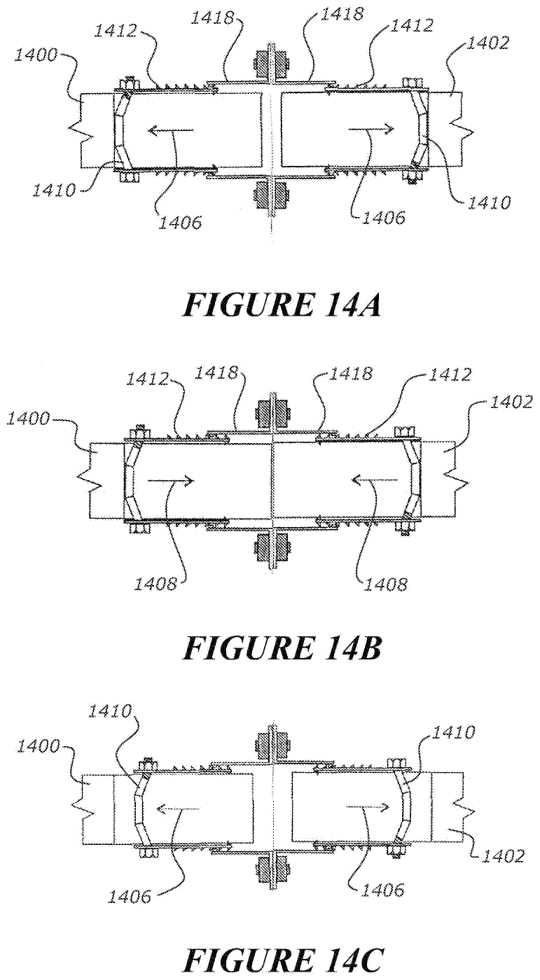

In one contemplated application two connectors, for example two of the connectors of the embodiment illustrated in FIG. 5, may be connected together to form a single combined connector. This is shown in FIG. 14A to 14C.

In the configuration seen in FIG. 14A the two connectors of FIG. 5 are shown joined together in an opposed fashion. To form the combined connector the first parts 1418 of the retainer of each connector are joined or fastened together. A first structural member 1400 and a second structural member 1402 are each provided, each structural member being associated with a respective second part 1412 of the retainers.

In FIG. 14A either or both of the first structural member 1400 and second structural member 1402 have been forced in the directions of the arrows 1406, ending the bolts 1410 and crushing the area of each respective structural member under the bolt.

In FIG. 14B either or both of the first structural member 1400 and second structural member 1402 have been forced in the directions of the arrows 1408, causing the ratcheting motion of the respective second parts 1418 and first parts 1412 of the retainers.

Further successive motion of either or both of the first or second structural members in the direction of the arrows 1406 results in further crushing of the material beneath the bolts 1410 of each retainer, resulting in further absorption of energy.

In the configuration of FIG. 14 the combined connector increases the total energy consumption of a connection, allowing more total material to be crushed.

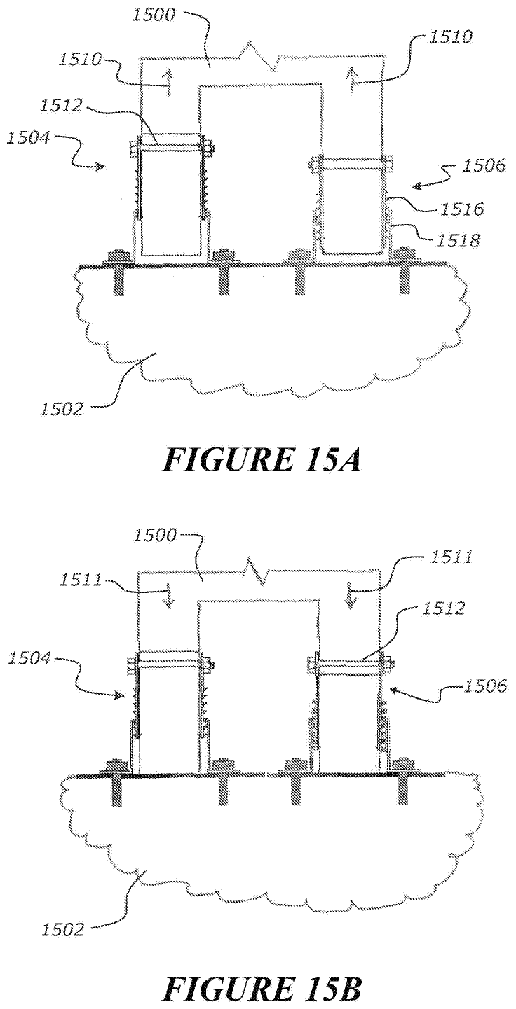

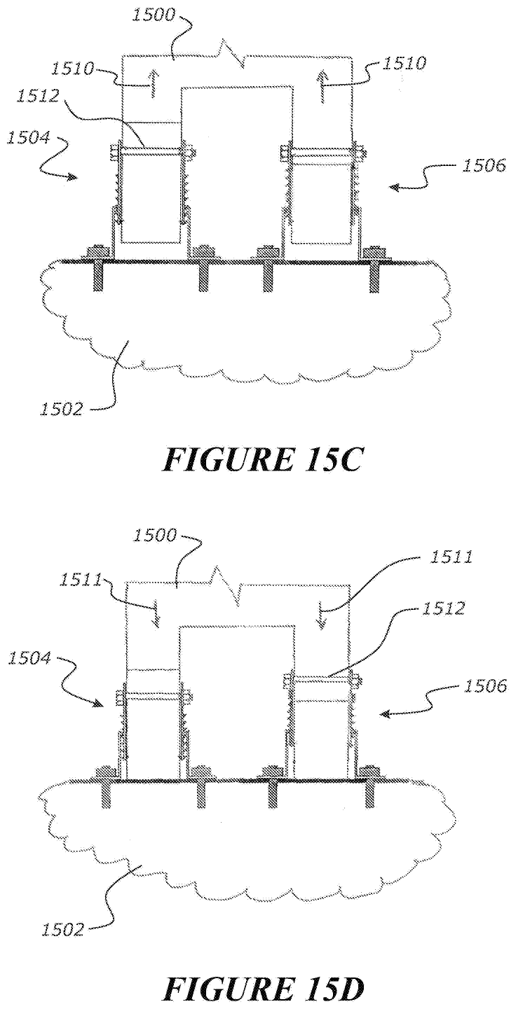

Another contemplated application of the connectors is shown in FIG. 15. As seen in FIG. 15A two connectors, each having its own retainer 1504 and 1506 respectively, are provided between the first structural member 1500 and second structural member 1502.

The orientation of the tooth or teeth and pawl or pawls of one of the retainers, here those of the retainers 1506, are oriented opposite to that of the other retainer, here retainer 1504. This allows one retainer to ratchet in a first direction but not in a second direction (being a direction substantially opposite to the first direction), while the other retainer resists motion in the first direction, but allows motion in the second direction. This allows energy to be absorbed by crushing of material by the movement of the first structural member 1500 in either the first or second direction.

As seen in FIG. 15A, the first structural member 1500 has been forced in the direction of the arrows 1510. As the retainer 1504 prevents motion in this direction, crushing occurs beneath the bolt or load bearing member 1512 of the first connector's retainer 1504. At the same time, the first part 1516 of the second retainer 1506 extends relative to the second part 1518 of the second retainer 1506, the tooth or teeth sliding over the pawl or pawls of each respective part.

Upon a forcing of the first structural member 1500 in an opposite direction, being a second direction as indicated by the arrows 1511, the first retainer 1506 ratchetably retracts, while the second retainer 1506 causes crushing of the material of the first structural member above its bolt 1512.

Upon further motion of the first structural member 1500 in the first direction, as indicated by arrows 1510, continued crushing occurs of the material of the first structural member beneath the bolt 1512 of the first connector's retainer 1504, while the second connector's retainer 1506 ratchets to a further extended position. This motion is seen in FIG. 15C.

Further motion of the first structural member 1500 in the direction of the arrows 1511 results in crushing of the material above the bolt 1512 of the second retainer 1506, while the first retainer 1504 ratchets to a further retracted position.

By providing a joint using the connectors as described in relation to FIG. 15, a structural connection characteristic may be provided wherein motion in either of the directions 1510 or 1511 results in crushing of the material of the first structural member, and resulting absorption of energy. In addition, the configuration of FIG. 15 also allows slack in the connection created due to the crushing to be taken up.

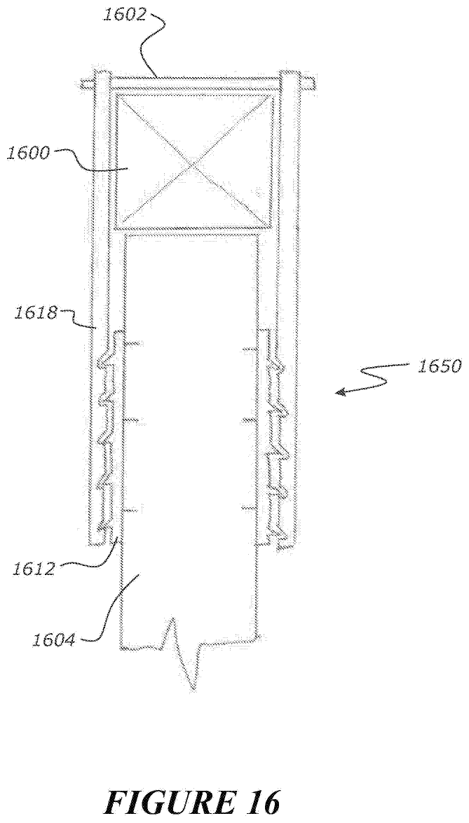

An additional embodiment is shown in FIG. 16. A first structural member 1600 and second structural member 1604. In this embodiment the first structural member 1600 may be any beam, preferably of a wooden or other crushable material. A cross section of the beam 1600 is shown in FIG. 16. The second structural member may be any other member, such as a substantially vertical support member, for example a vertical column. The vertical column may be made from the same material as the first structural member 1600, or a different material.

As seen in FIG. 16, the retainer 1650 has a first part 1612 and a second part 1618, wherein the first part 1612 is fixed to the second structural member 1604. However, the configuration of the retainer 1650 of this embodiment may be as shown in FIG. 16 or substantially as described with relation to any of the other embodiments described herein.

In the embodiment of FIG. 16 the load bearing member 1602 is arranged such that it comes into contact with the upper surface of first structural member 1600. Unlike in some previously described embodiments, no hole or aperture in or through the first structural member is provided to accommodate the load bearing member. Instead, the load bearing member 1602 initially bears against the outer surface of the beam. During operation of the joint according to cycles of motion as previously described, the top surfaces of the first structural member 1600 become crushed by the load bearing member, and the load bearing member progresses further into the first structural member.

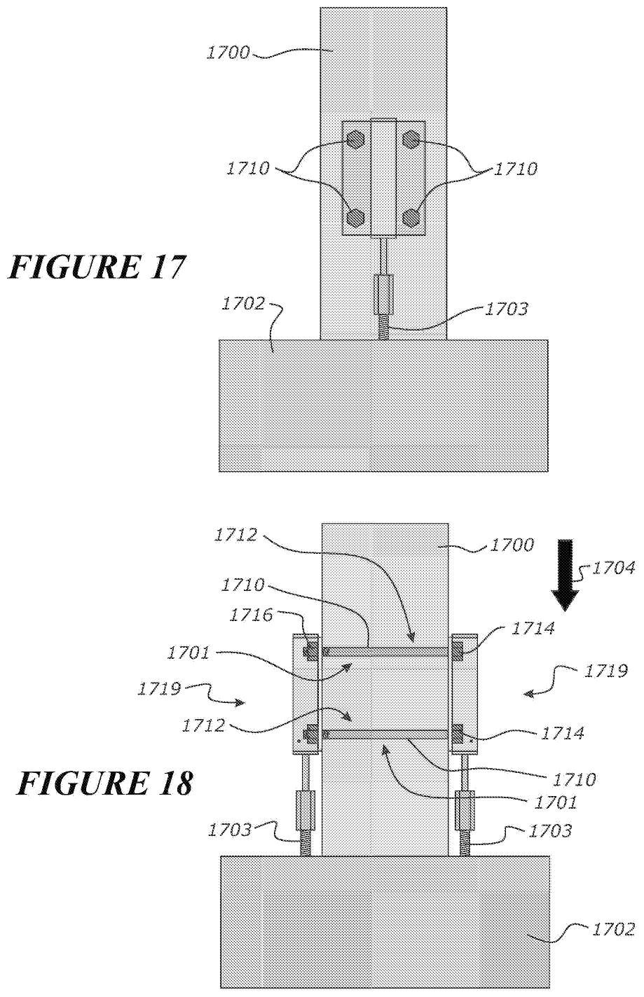

A further embodiment of connector which is believed to exhibit improved behavior over the prior art joint of FIGS. 1-3 is illustrated by way of example in FIGS. 17 and 18. The connector seen in FIGS. 17 and 18 similarly comprises a non-return mechanism as previously described in relation to the embodiments of FIGS. 4 to 16. However the operation of the non-return mechanism of the present embodiment connector 1719, seen in FIGS. 17 and 18, operates by way of a frictional engagement.

Shown in FIG. 17 is a connector 1719 of the present embodiment associated with a first structural member 1700 and second structural member 1702. The first and second structural members may be components of a building or structure such as a post, beam, joist, rafter, brace, wall or panel, or a foundation or footing. As described in relation to previous embodiments, for the purposes of the present invention one of the structural members is of a material that can yield classically under excessive force, for example by a crushing or tearing of fibres, to absorb significant amounts of energy.

The connector 1719 of FIG. 17 is associated with the first structural member 1700 by way of one or more load applying members 1710. The load applying member 1710 passes through a hole 1712 in or through the first structural member 1700. As shown in FIG. 17 the load applying member 1710 may be in the form of a bolt, and a plurality of bolts may be provided. Where the load applying members 1710 are in the form of a bolt as seen in FIG. 18 the bolt is preferably comprises a head 1714 and nut 1716.

The connector 1719 is further associated with the second structural member 1702. In the configuration shown in FIG. 17 the association with the second structural member 1702 is by way of connection to a fixture such as an anchor bolt 1703 which is integrated into or provided as part of the second structural member 1702. Where the second structural member 1702 is a foundation for footing a fixture such as an anchor bolt may be readily available; however where the second structural member is another type of structural member any other commonly available means of structural attachment to the second structural member 1702 may be utilised.

Shown in FIG. 18 is a side view of the configuration of FIG. 17. Two connectors 1719 are each associated with a first structural member 1700 by the load applying members 1710, and to the second structural member 1702 by their connections to the anchor bolts 1703. The two connectors 1719 of FIG. 18 are located on opposed sides of the first structural 1700 and share the load applying members 1710.

While in relation to previous embodiments connectors or connector components may preferably be tensioned together across the first structural member 1700 by a tensioning of the bolt or bolts 1710, in relation to the present configuration comprising the connector 1719 there may be no such requirement for tension of the bolts 1710. In fact, it is preferred in the current configuration that the connectors 1719 are not tensioned by the bolts 1710 so that they are not in forced contact with the first structural member 1700. The functionality of this configuration will become apparent by the following description of the operation of the connector 1719.

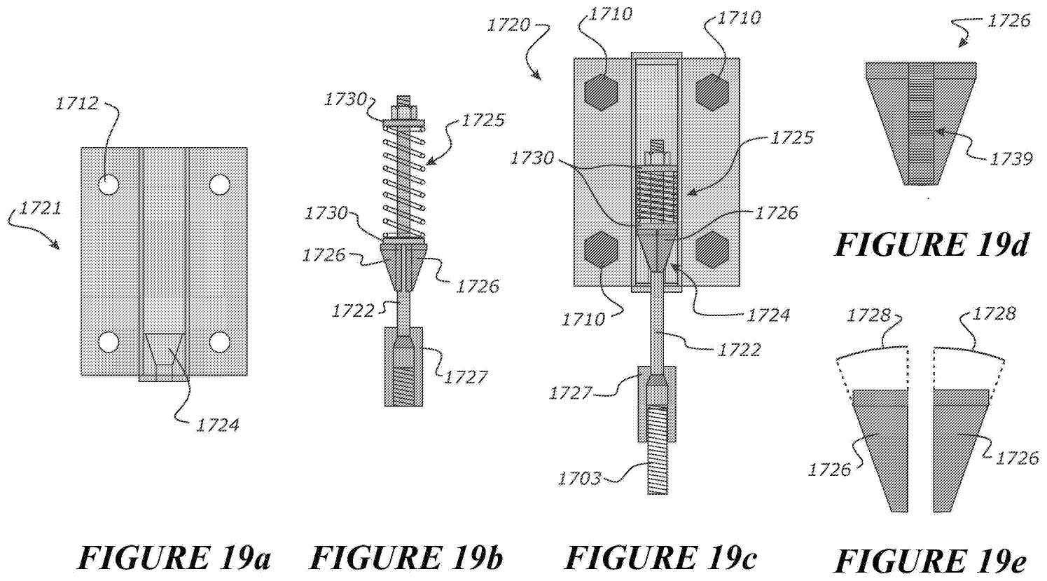

The function and operation of a connector 1719, and more particularly a non-return mechanism 1720 of a connector 1719 will now be described with reference to FIGS. 19A to 19C.

The connector 1719 preferably comprises a non-return mechanism 1720, shown in FIG. 19C. The non-return mechanism 1720 is operable between a engaged condition wherein the load applying member 1710 is resisted from moving, or preferably prevented from moving, in one direction relative to the second structural member 1702, and a disengaged condition wherein the load applying member 1710 may be allowed or caused to move in an opposite direction relative to the second structural member 1702.

Shown in FIG. 19A is a first mechanism member or housing 1721 which comprises part of the non-return mechanism 1720. The first mechanism member or housing 1721 is to be connected to the load applying member or members 1710, for example by an extension of the load applying member 1710 through a hole 1712 of the first structural member.

The connection between the one or more load applying members 1710 and the first mechanism member or housing 1721 of a connector 1719 is preferably that of a fixed connection such that a force applied to the one or more load applying members or bolts 1710 may be directly transmitted to the first mechanism member 1721 of a connector.

In a preferred embodiment shown in FIG. 19A the first mechanism member 1721 further comprises at least one wedging surface 1724. The at least one wedging surface 1724 may comprise two substantially opposed wedging surfaces, or as seen in the partial cross section of FIG. 19A may comprise a substantially continuous surface. Where the at least one wedging surface 1724 is a substantially continuous surface, it is preferably of a substantially conical or frustoconical shape, as is shown in FIG. 19A.

In alternative forms it is contemplated that the wedging surface 1724 may not comprise part of the first mechanism member or housing 1721, but may rather be provided as a separate component of the non-return mechanism 1721 or as part of a second mechanism member 1722.

With reference to FIG. 19B further elements of the non-return mechanism 1720 are shown. A second mechanism member 1722 of the non-return mechanism 1720 is to be associated with the second structural member 1702. As seen in FIG. 19B, the second mechanism member 1722 is in the form of a rod. The rod 1722 is provided with a connecting sleeve 1727 for threading connection to an anchor bolt 1703 of the second structural member 1702. While in the preferred form the second mechanism member 1722 connects to the second structural member or foundation 1702 by way of a connecting sleeve 1727 to an anchor bolt 1703 of the foundation, any range of other commonly available and practiced forms of structural connection may be utilised to connect the second mechanism member 1722 to the second structural member 1702.

Associated with the second mechanism member 1722 is at least one wedge 1726. As shown in FIG. 19B, two wedges 1726 are provided. The wedge or wedges 1726 are preferably of a shape and size to substantially correspond with the at least one wedging surface 1724 of the first mechanism member 1721. Where the wedging surface 1724 is of a substantially conical or frustoconical form as shown in FIG. 19A, the wedges 1726 have surfaces that at least in part substantially correspond to the wedging surface 1724, being a similarly conical or frustoconical body.

The wedges 1726 are arranged around the body of the second mechanism member or rod 1722, and preferably have internal surfaces that correspond with the rod. The wedge elements 1726 shown in FIG. 19B are configured such that if the wedge elements are moved towards each other their internal surfaces contact the second mechanism member or rod 1722 before the wedge elements come into contact with each other. Such a configuration may allow the wedge elements 1726 to frictionally engage with the second mechanism member 1722.

In order to assist the at least one wedge 1726 in frictionally engaging with the surface of the second mechanism member or rod 1722 the internal face of at least one wedge element may be provided with at least one projection, such as in the form of a tooth or serration 1739. These teeth or serrations 1739, seen in FIG. 19D may act to provide at least initially regions of increased pressure of the wedge 1726 against the rod 1722, and under further forcing may act to bite into and securely engage with the surface of the second mechanism member 1722.

Associated with the second mechanism member 1722 is a bias 1725, configured to bias the wedge elements 1726 towards the wedging surface 1724. As shown in FIG. 19B the bias 1725 comprises a spring. Alternatively, other commonly available forms of biasing may be employed, such as the weight of a mass.

An assembled non-return mechanism 1720 comprising the first mechanism member 1721 and second mechanism member 1722 as previously described is shown in FIG. 19C. As seen in FIG. 19C the first mechanism member or housing 1721 has been connected to the one or more load applying members 1710, and the second mechanism member or rod 1722 has been connected to an anchor bolt 1703 by the threaded connecting sleeve 1727. Under the force of the bias 1725 the wedges 1726 are driven against the corresponding wedging surface 1724 of the first mechanism member or housing 1721.

Due to the inclination of the wedging surface relative to the direction of force applied along the axis or axial direction of the rod 1722 the wedge elements 1726 are caused to be driven towards each other and wedged between the wedging surface 1724 and second mechanism member 1722. In this condition the wedges may be said to be frictionally engaged with the second mechanism member or rod 1722.

As a result of the frictional engagement, movement of the housing 1721 and rod 1722 away from each other may be prevented. This configuration may be said to be the engaged condition of the non-return mechanism 1720. Because the housing and rod are prevented from movement away from each other due to the frictional engagement of the wedges 1726, the at least one load applying member 1710 which is connected to the housing 1721 is also prevented from movement away from the anchor bolt 1703 or second structural member 1702.

The non-return mechanism 1720 also has a disengaged condition wherein the first mechanism member 1721 and second mechanism member 1722 may move towards each other. In order to operate the non-return mechanism to its disengaged condition the first mechanism member or housing 1721 may be moved towards the projecting portion of the second mechanism member or rod 1722, such that the wedging surface 1724 is moved away from the wedges 1726. Alternatively, the bias 1725 may be provided such that it may be engaged or disengaged. Further alternatively the bias may be reversible, so that it may cause the wedges 1726 to be biased towards either of their engaged condition or disengaged condition in relation to the wedging surface 1724.

The engaged and disengaged conditions of the non-return mechanism 1720 are consequently also the engaged and disengaged conditions of the connector 1719.

In the configuration of FIG. 19C if the housing is moved in the first direction 1704 relative to the rod 1722, an initial disengagement of the wedging surface 1724 and wedges 1726 may result, but the wedges 1726 will be driven back into engagement with the wedging surface 1724 by the bias 1725. By such an action of the bias the non-return mechanism 1720 itself may be biased towards its engaged condition.

With reference to FIG. 19C the disengaged condition of the non-return mechanism 1720 may allow a movement of the at least one load applying member or bolt 1710 connected to the housing 1720 to move towards the anchor bolt 1703 and second structural member with which it is associated.

An example wedge angle 1728 of a pair of wedges 1726 is shown in FIG. 19E. The wedge angle 1728 is defined as the angle between the outer surface of a wedge 1726 and the surface of the second mechanism member 1722 onto which the wedge is applied.

In a preferred form the performance of the non-return mechanism 1720 of the connector 1719 is such that when it is in its engaged condition, an increase in the forced motion of the first and second mechanism members away from each other results in a proportional increase in a frictional force provided by the wedge to resist the relative movement of the first and second mechanism members. Preferably the frictional force generated is sufficient to prevent the relative movement of the first and second mechanism members.

In order to provide a maximum frictional force between the wedges and second mechanism member the wedging angle 1728 may be provided as 45 degrees. However, preferred embodiments may utilise a range of different wedge angles in order to provide differing characteristics dependent on the application. For example, the wedge angle may vary dependent on the relative material types of the wedges 1726, wedging surface 1724, and the second mechanism member 1722. Additionally, the wedge angle may be varied dependent on the magnitude of bias provided by the biasing member 1725. Dependent on the configuration of these variables, the wedge angle 1728 utilised in the non-return mechanism 1720 of the present connector may be any angle nominally less than 90 degrees to an angle nominally greater than 0 degrees.

When the non-return mechanism 1720 is provided as part of the connector 1719 a forced movement of the first mechanism member or housing 1721 in the second direction 1704 is provided by a bearing of the associated load applying member 1710 against crushable portion of the first structural member 1700. It is the bearing force against the load applying members in the second direction 1704, and consequential force applied on the first mechanism member 1721 in the second direction, which provides a forcing of the wedging surface 1724 against the wedges 1726 to oppose the bias of the biasing member 1725.

Accordingly, a sufficient decrease in the bearing force by the first structural member on the load applying member may result in a disengagement of the non-return mechanism as the wedges 1726 are no longer wedged into engagement by the wedging surface 1724.

In a preferred form where the non-return mechanism comprises a bias 1725 of the wedges, the non-return mechanism may be operated into its disengaged condition when the bearing force of the first structural member against the load applying members in the second direction 1704 falls to a value below the biasing force applied by the bias 1725 on the wedges 1726 in the first direction 1706. More particularly, the operation to the disengaged condition may occur when the bearing force falls to a value sufficiently beneath that of the force exerted by the bias 1725 such that the static frictional engagement between the wedges 1726 and second mechanism member 1722 may be overcome.

In alternate embodiments where no bias 1725 of the wedges is provided, the disengagement of the non-return mechanism may occur only under a movement of the load applying members and first mechanism member in the second direction 1704.

In some alternate embodiments a further bias may be provided between the first and second mechanism members to bias them towards each other, so as to result in the disengagement of the non-return mechanism when the bearing force in the second direction 1706 on the load applying members is below a certain value but still above the magnitude of the force provided by the bias 1725 of the wedges.

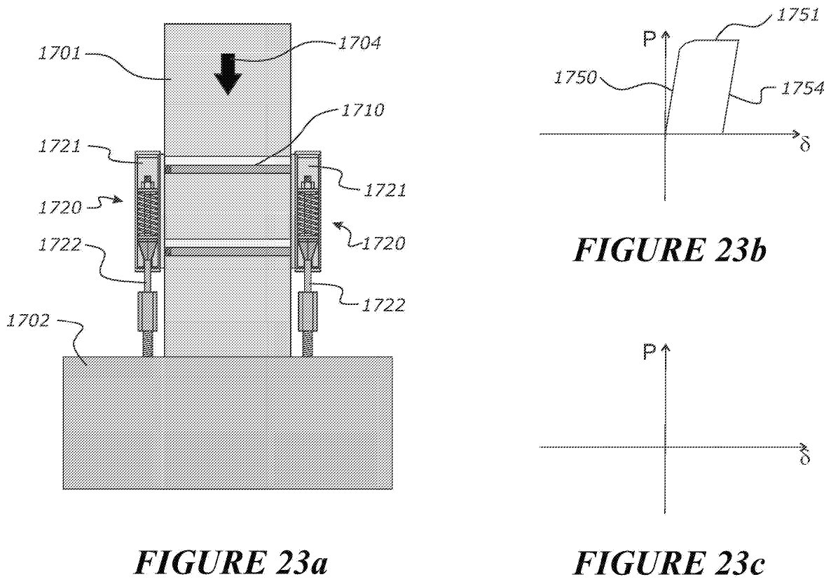

It may be desirable to provide the connectors 1719 and load applying members 1710 as in the configuration seen in FIG. 18 such that there is little or no contact between the connectors 1719 and the side faces of the first structural member 1700. Accordingly, where there has been a crushing of the crushable portion 1701 of the first structural member due to a movement of the first structural member in the second direction 1704, as shown in FIG. 23A, when the bearing force in the second direction on the load applying members is less than the weight of the connector and load applying member the non-return mechanism 1720 may be caused to disengage and allow movement of the first mechanism member and load applying members towards the second structural member.

Although the weight of the second structural member and load applying members would in FIG. 23A act in the first direction 1703, in other configurations the connector and load applying members may be oriented differently.

As shown in FIG. 19C the rod 1722 is configured to slide within a channel of the housing 1721. The rod 1722 may be constrained within the channel by the sizing of the opening of the channel, and potentially also by one or more washers or other spacing elements 1730 which may also act to constrain the bias 1725 where the bias is in the form of a spring.

While such constrained movement the rod 1722 within the housing 1721 may be preferable, in alternate forms this housing enclosure may not be present. Additionally, the first mechanism 1721 may not necessarily be in the form of a closed housing, but in any form suitable for connecting the load applying member or members 1712 and providing a wedging surface 1724. Similarly the second mechanism member 1722 may not necessarily be in the form of a rod, but may be of any other form suitable to be clamped to. For example, it may comprise square sided elongate bar, or even some other non-elongate shape.

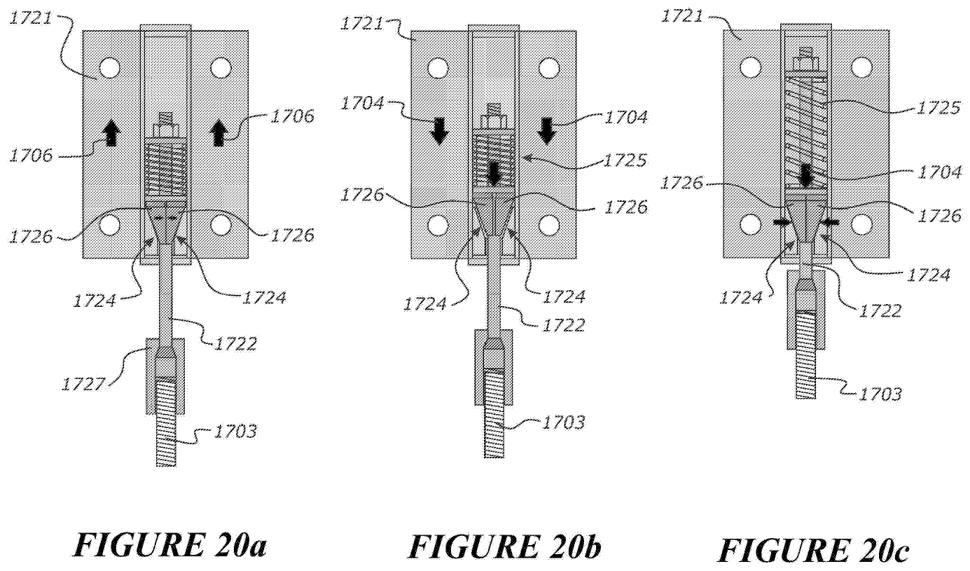

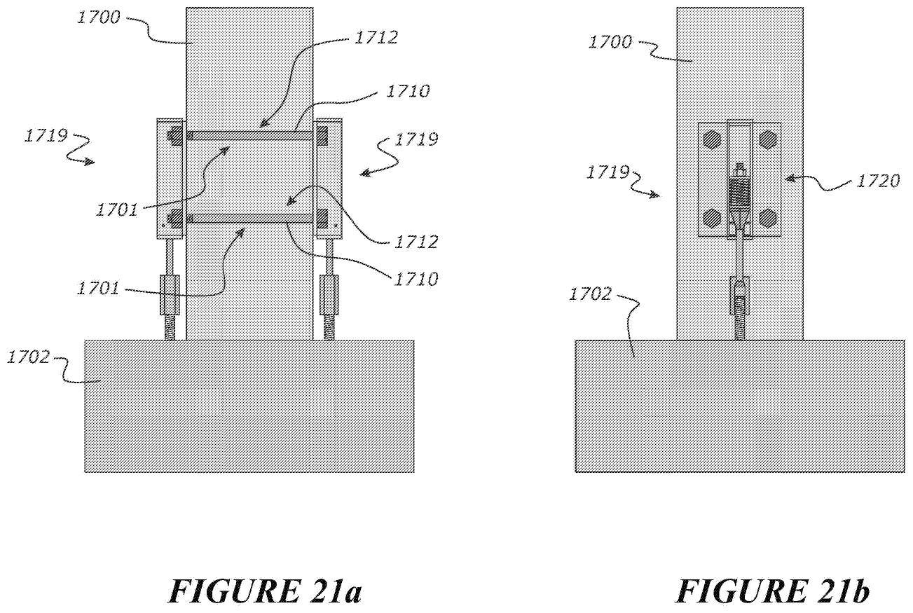

With reference to FIGS. 20A to 20D, the operation of the non-return mechanism 1720 between its engaged and disengaged conditions during a cycle of forced movements of the first mechanism member 1721 in the first direction 1704 and the second direction 1706 will now be described.

As discussed in relation to FIG. 19C the biasing member 1725 in the preferred embodiment acts on the wedges 1726 to drive them into contact with the wedging surface 1724, to result in an initial frictional force between the wedges and the second mechanism member 1722, so that the default state of the non-return mechanism 1720 is its engaged condition.

In FIG. 20A the first mechanism member 1721 has been forced in the second direction 1706 relative to the second mechanism member 1722 and connected anchor bolt 1703. The movement of the first mechanism member causes the wedging surface 1724 to act on the wedges 1726 and to force them into further frictional engagement with the second mechanism member 1722. This acts to prevent further movement of the first mechanism member 1721 in the second direction 1706.

In FIG. 20B the first mechanism member 1721 has been forcibly moved in the first direction 1704 relative to the second mechanism 1722. Due to this movement, the wedging surface 1724 has become separated from the wedges 1726, or at least the contact force between them is reduced to the force provided by the bias 1725. Dependent on the nature of the biasing force provided by the bias 1725 such a separation may require an abrupt forced movement of the first mechanism member 1721. Under less abrupt forced movements, there may in fact be no separation, but just a reduction in the contact force between the surfaces.

Following or simultaneous with the movement of the first mechanism member 1721 in the first direction 1704 the biasing member 1725 preferable acts in the first direction on the wedges 1726 to cause them to return to contact or remain in contact with the wedging surface 1724.

The following state is illustrated in FIG. 20C where the biasing member 1725 has urged the wedges 1726 in the first direction 1704, causing them to interact with the wedging surface 1724 and frictionally engage with the second mechanism member 1722.

The subsequent state of the non-return mechanism 1720, under a return to a forced movement of the first mechanism member 1721 in the second direction 1706 under a cycles of forced movement is shown in the already described FIG. 20A.

FIGS. 21A and 21B show a front and side view of a first structural member 1700 and second structural member 1702 connected by two connectors 1719. In FIG. 21A the load applying members 1710 may be seen located in the holes 1712 in the first structural member, and bearing in the first direction 1704 against the crushable portions 1701 of the first structural member. The partial view of the connector 1719 shown in FIG. 21B details the non-return mechanism 1720, as described previously, which the connector 1719 comprises.

With reference to subsequent Figures the configuration of FIGS. 21A and 21B will be described in relation to its operation during forced cycles of movement in the first direction 1706 and second direction 1704.

There are two different possible cases of behavior possible for the crushing of the crushable portion by a load applying member. In a first case, the load applying member or bolt is caused to bend due to an initial forced movement of the first structural member. This results in energy absorbed by the elastic and plastic deformation of the bolt during the first forced movement of the first structural member. During subsequent movements of the first structural member in the second direction 1704 energy is absorbed primarily or only by the crushing of the crushable portion. The behavior and energy absorption in this case where the bolt bends would be substantially similar to that shown and described in relation to FIGS. 6A to 16.

In a second case the load applying member or bolt is not caused to bend during crushing. In this case less energy may be absorbed by crushing during the initial movement of the first structural member in the second direction 1704, but the reusability and predictability of behavior of the connector may be improved.

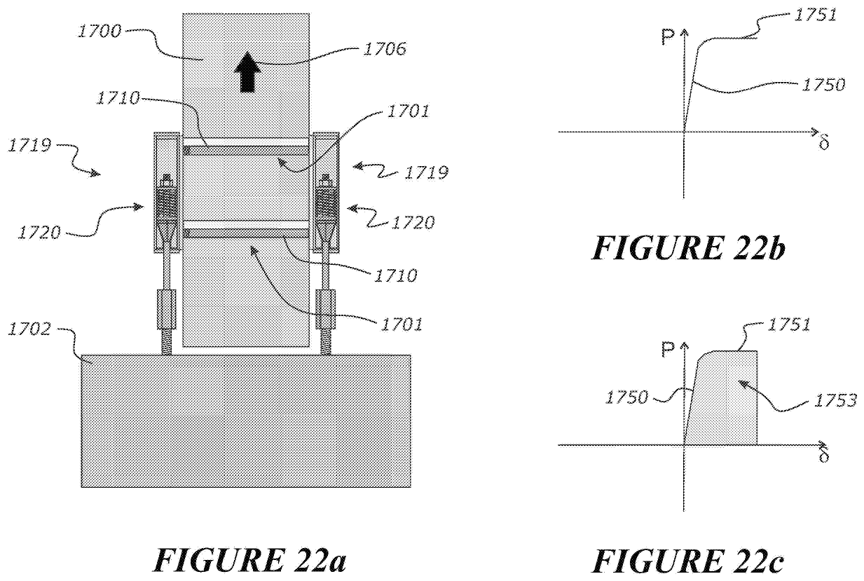

In FIG. 22A the first structural member or post 1700 has been forced upward away from the second structural member or foundation 1702 in the second direction 1706. As previously described, due to either or both of the default condition of the non-return mechanism being operated into its engaged condition due to the upwards movement of the post, the load applying member 1710 are retained in relation to the foundation 1702 and a crushing of the crushable portion 1701 of the first structural member results. This is seen in FIG. 22A.

The load slip curve for this stage of the event is illustrated in FIG. 22B. Load builds initially in elastic deformation of the crushable portion of the post, then plateaus as the crushable portion begins to plastically yield. The energy absorbed is illustrated by the shaded area 1753 under the curve in FIG. 22C.

In FIG. 23A, in the next opposite cycle loading, the first structural member or post 1700 has been forced in the first direction 1704 towards the second structural member or foundation 1702. As previously described, this movement of the post causes an operation to the disengaged condition of the non-return mechanism 1720 of each connector 1719, such that the first mechanism member 1721 may be caused or allowed to move in the first direction 1704 relative to the second mechanism member 1721 and foundation. The movement of the first mechanism members 1721 towards the foundation 1702 in the first direction 1704 is preferably such that the load applying members 1702 associated with each connector is caused to remain in contact with, or at least return to contact with the post 1700 during or following its movement in the first direction 1704. A load slip curve for this stage of the cycle is shown by the line 1754 in FIG. 23B. Negligible or no energy is absorbed by this stage of the cycle, as shown in FIG. 23C.

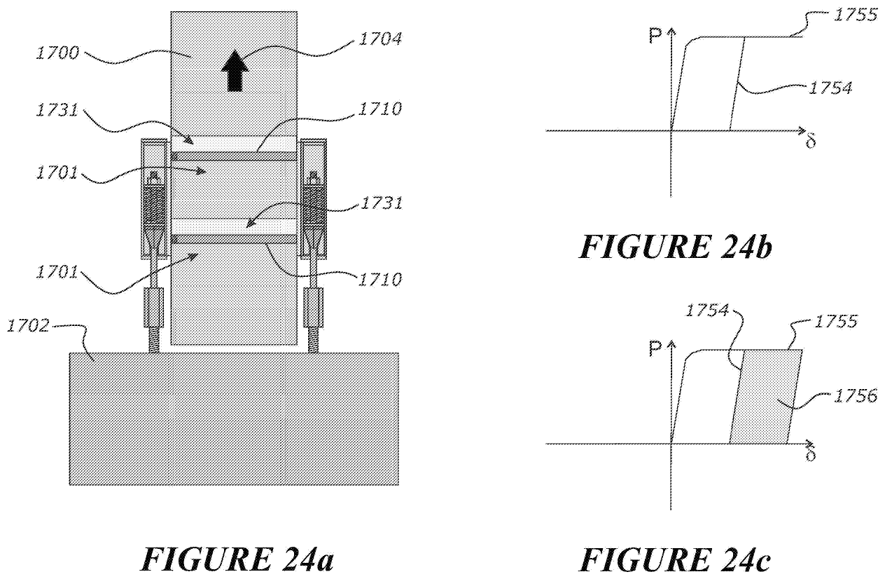

In FIG. 24A the post 1700 has been forced in the second direction, the direction of the arrow 1704, again. The displacement of the post results in further crushing of the crushable portion 1701 of the post by the load applying members 1710. A load slip curve for this stage of the event is illustrated in FIG. 24B by the lines 1754 and 1755. The plastic yielding of the crushable portion 1701 continues during this cycle, and a widened gap 1731 is opened behind each of the load applying members.

The energy absorbed is illustrated by the shaded area 1756 in FIG. 24C. This is substantially greater than in the equivalent shaded area in FIG. 3C for the prior art example.

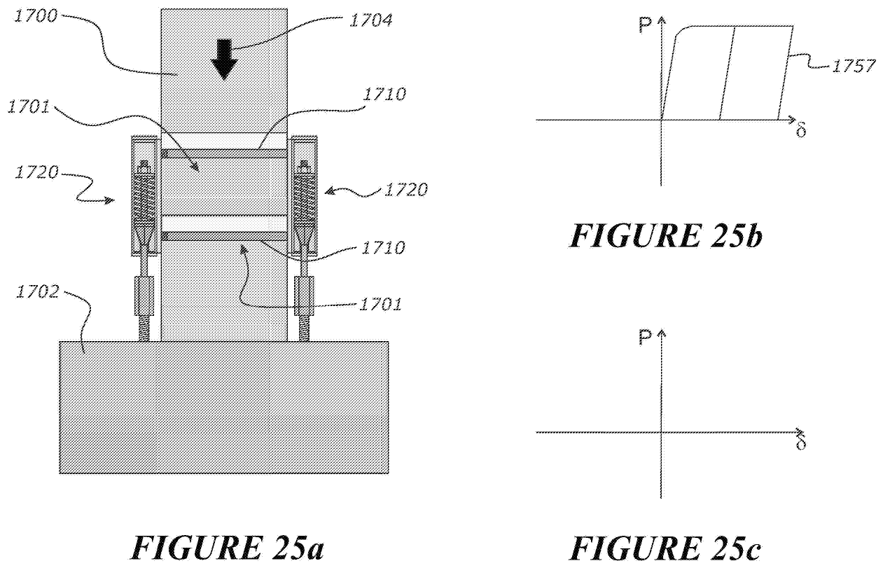

Finally, in FIG. 25A the post 1700 has been forced again in the first direction 1704, releasing load on the crushable portion 1701. During this portion of the cycle the non-return mechanism 1720 of each of the connectors 1719 are operated to their disengaged condition, allowing a progression of the first mechanism members towards the second mechanism members and foundation. This acts to maintain or return the load applying members to bearing contact on the crushable portions 1701 of the post. A load slip curve for this stage of the event is illustrated in FIG. 25B by the line 1757. Little or no energy is usefully absorbed in this stage of the cycle, as shown in FIG. 25C.

As described previously the cyclical motion as has been described in relation to FIGS. 20A to 25C may occur under some external forcing event. For example, where the first structural member is a post and the second structural member is a foundation upon which the post rests, these cycles of forced movement of the post may take place during an earthquake, wind loading, or other event where the post is lifted up from the foundation then dropped back towards it.

While shown with the connectors 1719 in a vertical orientation in the previously described Figures, the connectors may be applied in any range of possible angular orientations.

Although the connectors have been shown in the configuration of FIG. 18 with two connectors disposed on opposite faces of a first structural member 1700, a single connector 1719 may be utilised in a structural connection.

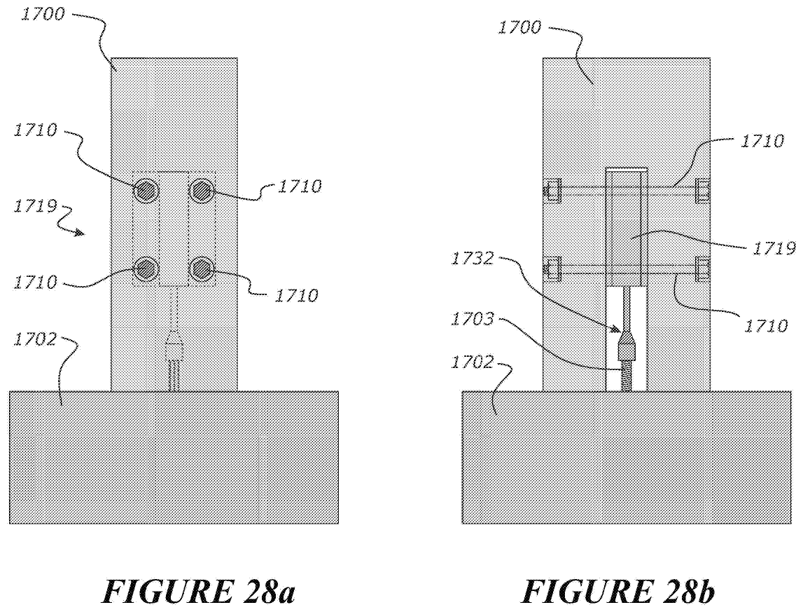

Such a configuration with a single connector is shown in FIG. 28A and 28B, where the connector 1719 lies recessed within a slot 1732 within the first structural member 1700. Such a configuration may be desirable where for aesthetic reasons the connector 1719 should not be visible.

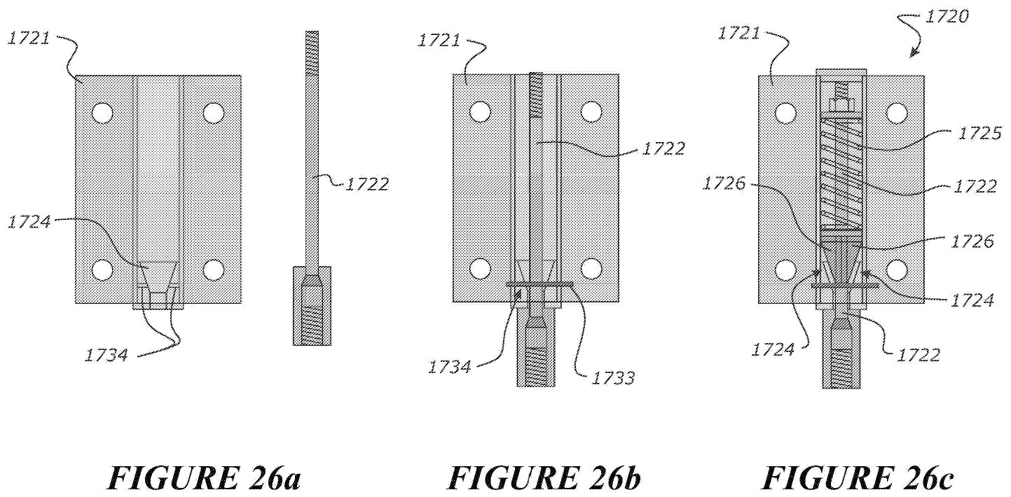

It may be desirable either when assembling, installing, or at various periods during the lifetime of the connector 1719 to be able to disengage the non-return mechanism 1720. This disengagement may be desired for example to prevent the retraction of the second mechanism member 1722 into the first mechanism member housing 1721, or to be able to withdraw the second mechanism member from the housing. While not shown in the partial views of FIGS. 26A to 26C, it is contemplated that the wedges 1726 and bias member 1725 may be substantially enclosed by the housing 1721. In such a case the wedges may not easily be accessed to force them into a disengaged position, away from the wedging surface 1724.

Accordingly, the first mechanism member 1721 may be provided with a hole 1734 passing through the wedging surfaces 1724. Within the hole 1734 may be inserted a disengagement element 1733. The disengagement element may preferably be in the form of a pin or other resilient projection. The pin 1733 inserted into the hole 1734 may be seen in FIG. 26B. As shown, preferably the hole 1734 is located such that pin may pass through it without interfering with the second mechanism member 1722.

An assembled non-return mechanism 1720 having the pin inserted into the hole 1734 is shown in FIG. 26C. The presence of the pin 1733 prevents the wedges 1726 from being forced into engagement with the wedging surfaces 1724 by the bias member 1725. As a result the non-return mechanism is maintained in its disengaged condition, regardless of any relative movement between the first and second mechanism members.

While the pin may be inserted into the hole 1734 during the assembly of the non-return mechanism before the wedges and bias member are installed, the pin may also be operable to when inserted cause the wedges to move from their engaged condition to their disengaged condition.

In order to achieve this disengagement of the already engaged wedges, the holes 1734 may be located to just in part pass through the wedging surface 1724. The pin 1733 may further be adapted to unseat the wedge from its engaged condition by providing the pin with a tapered shape so that the projection may at first likely engage with the wedges, then as it is forced further into the hole 1734 gradually force the wedges 1726 away from their engaged condition.

Additionally, a set of holes 1734 and pins 1733 may be provided on opposing sides of the wedging surface 1724 so as to allow a symmetrical force to be applied on the wedges to move them away from their engaged condition.

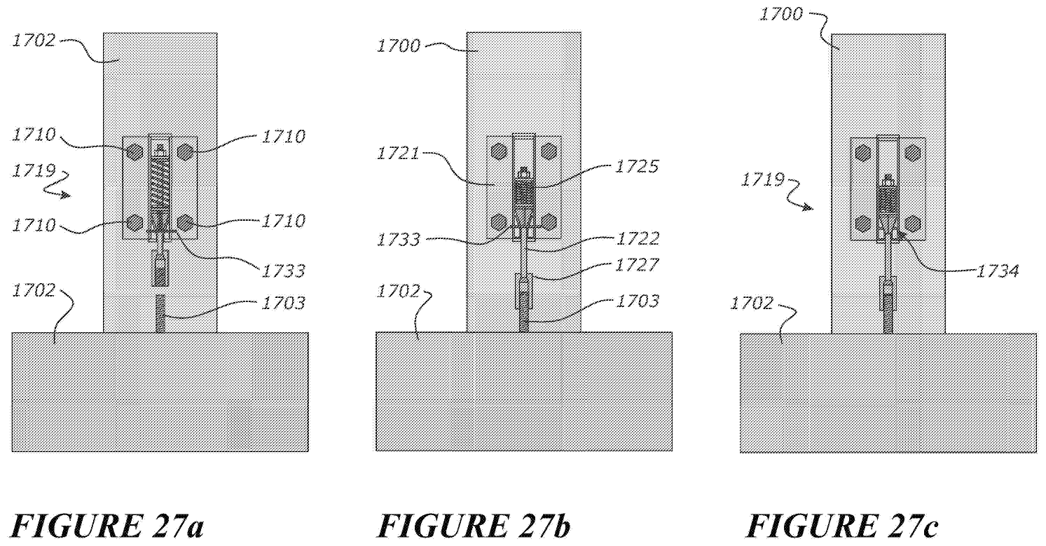

A method of installation of the connector 1719 will now be described with reference to FIGS. 27A to 27C. An assembled connector 1719 may preferably be provided in a condition with the disengagement element 1733 inserted in the hole 1734 so that the connector is maintained in its disengaged condition. Such a connector 1719 may first be located over an anchor bolt or other fixing element 1703 of the second structural member 1702. In a preferred form two such connectors 1719 may be provided opposite each other on the first structural member 1700. The connector or connectors are then associated with the first structural member or post by way of the one or more load applying members 1710 pass through holes 1712 in the first structural member 1700.

With the disengagement element located in the hole and the connector maintained in its disengaged condition, the connecting sleeve 1727 may be pulled downwards, drawing the second mechanism member 1721 with it and compressing the bias spring 1725. The connecting sleeve 1727 may then be threadably connected to the anchor bolt 1703, for example to a screw thread of the anchor bolt.

Once these connections between the connector 1719 and the first and second structural members have been provided, the disengagement element 1733 may be withdrawn from the hole 1734, allowing the connector to return to its engaged condition under the bias 1725. The installed connector 1719 is now ready to undergo cycles of forced movement.

After an external event has caused cycles of forced movement of the first structural member relative to the second structural member at least part of the crushable portion 1701 of the first structural member may have been crushed in order to absorb energy of the external event. As the amount of crushing available in the crushable portion may be limited, or the travel of the first and second mechanism members towards each other may be limited, it may be desirable to reset the connector to its initial configuration.

When servicing the connector 1719 for reuse, the load applying member 1710 must first be returned to its original location by moving it in the second direction 1706. In order to enable this movement of the load applying member and connected first mechanism member or housing 1721 the non-return mechanism 1720 must first be operated into its disengaged condition.

Operating the non-return mechanism to its disengaged condition may be done using any means of removing the wedges 1726 from engagement with the wedging surface 1724, but preferably by the insertion of a disengagement element 1733 into the hole 1734 passing through the wedging surface 1724, as has been previously described.

Following the insertion of the disengagement element, the non-return mechanism is caused to be in its disengaged condition and the first mechanism member 1721 and load applying member 1710 may be freely moved in the second direction 1706. With the load applying member no longer bearing on the crushed surface of the crushable portion 1701 the crushable portion may be repaired or replaced.

This servicing of the crushable portion 1701 may be by the addition of further material to be crushed, or where the crushable portion comprises a replaceable element, the removal of the old portion and insertion of a new crushable portion.

The disengagement element 1733 may then be removed from the hole 1734, allowing the non-return mechanism 1720 to transition to its engaged condition under the bias of the biasing member 1725. Preferably the load applying member and first mechanism member are returned in the first direction 1706, either by their own weight or a bias provided to them, such that the load applying member 1710 bears against the newly replaced or renewed crushable portion 1701.

By providing a connector 1719 capable of servicing and re-use simply by the readjustment of the parts of the connector and replacement or refurbishment of the crushable portion 1701 a structural connection may be provided which is capable of absorbing energy from multiple external events. As the servicing and re-use may only require the replacement of the crushable portion, the re-use may come at a advantageously lower cost than prior art structural connections for the absorption of external event energy which require extensive refurbishment or replacement of their structural components prior to re-use.

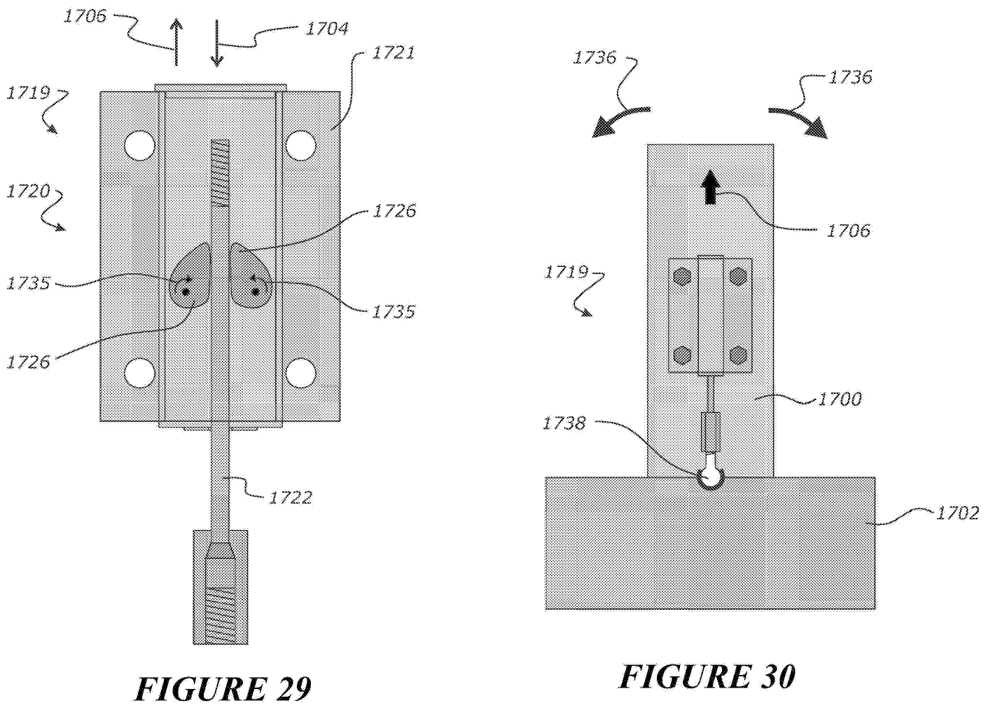

While the wedge 1726 has so far been described as a wedge or wedge element which may be displaced linearly to cause an engagement of the wedge or wedges, other forms of the non-return mechanism 1720 are contemplated involving other forms of wedging. For example, shown in FIG. 29 is a non-return mechanism 1720 of a connector 1719 wherein the wedges 1726 comprise a pair of cam members. The wedge elements 1726 are pivotably connected to the first mechanism member 1726 of the non-return mechanism. The cams 1726 are biased inwardly in the direction of the arrows 1735 towards engagement with the second mechanism member 1722.

The cam wedges 1726 of FIG. 29 are oriented and shaped such that they present a surface to engage with the second mechanism member, and are not able to rotate inwards without interfering with the second mechanism member. An inwards rotation is a rotation in the direction of the arrows 1735 for each cam. The cams are also configured to allow rotation in the direction opposite the arrows 1735, so that the cams may roll away from engagement with the second mechanism member.

Under a movement of the first mechanism member 1721 in the second direction 1706 relative to the second mechanism member 1722 the cams 1726 will be caused due to the initial friction from their inward biasing to further pinch and frictionally engage with the second mechanism member 1722.

Conversely, under a movement of the first mechanism member towards the second mechanism member in the direction, a movement of the first mechanism member in the first direction 1704, the initial engagement between the surfaces of the wedges and the second mechanism member will cause the cams to rotate in the direction opposite the direction of the arrows 1735, further disengaging the cams from the second mechanism member.

The connector 1719 has so far been described in relation to configurations where it is associated with the second structural member 1702 by way of a fixed connection, such as a threaded connection of the second mechanism member 1722 to an anchor bolt 1703 of the second structural member or foundation. Such a configuration in combination with the operation of the non-return mechanism 1720 allows forced movement of the first structural member 1700 to occur in the first direction 1704 and opposite second direction 1706. In other words, the connector in this configuration provides one degree of freedom of the first structural member or post relative to the second structural member or foundation.

In some applications this single degree of freedom behavior may be allowable. However, not all forcing of a post 1700 due to an external event may occur in one degree of freedom. Components of the external forcing may act on the post, urging it into other out of plane movements. In order to absorb the maximum amount of energy from the external event, it may be desirable to cause progressive crushing of the crushable portion of the post during some or all of the other components of any out of plane movement.

For example, as shown in FIG. 30, it may be desirable to allow crushing to occur during both movements of the post 1700 in the second direction 1706 and direction opposite the second direction, and also in at least the rotational directions 1736 and 1737. In order to allow movement of the post in the rotational directions 1736 and 1737 the connector 1719 must be able to articulate relative to the second structural member or foundation 1702, yet remain fixedly connected thereto in order to enable the engagement and disengagement of the non-return mechanism of the connector.

In the example shown in FIG. 30 the association between the second mechanism member 1722 of the connector and the foundation is by way of a pivotable connection 1738. The pivotable connection preferably allows at least some rotation, yet retains the second mechanism member relative to the foundation. An example of such a pivotable connection may be a ball and socket joint.

It is contemplated that the pivotable connection 1738 may be configured to allow only certain desired degrees of freedom of the post relative to the foundation. For example, if only movement in the first and second directions, and the rotational directions 1736 and 1737 are desired to be allowed the pivotable connection 1738 may be in the form of a hinging connection. Alternatively, where all three rotational degrees of freedom are to be allowed, a ball and socket joint may be provided.

While the connector 1719 has been primarily been shown in the configuration with a post and foundation where two connectors are used, one each on opposed sides of the post, the configuration of FIG. 30 for allowing additional degrees of freedom may utilise either the stubble connector set up or only the single connector visible in FIG. 30. Similarly, the pivotable connection 1738 may be utilised in any other forms of the connection herein described, particularly in the configuration of FIGS. 28A and 28B where the connector 1719 is provided internally in the first structural member.

The connector 1719 is capable of providing a continuous engagement of its non-return mechanism 1720, such that the first and second mechanism members may be in their engaged condition at any point along their travel relative to each other, and that the disengaged condition of the non-return mechanism may allow the relative movement of the first and second mechanism member towards each other in distances of any increment size. This functionality is provided due to the ability of the wedge elements 1726 to frictionally engage with the second mechanism member 1722 at any point along its length.

This functionality of the connector 1719 may have advantages over the ratcheting or material interference form of non-return mechanism described in relation to the connector of FIGS. 4 to 16, as that form of non-return mechanism may provide an indexed characteristic of the movement of its parts rather than a continuous characteristic.

A further potential advantage of the connection 1719 is that given its continuous nature when combined with the bias 1725 of the non-return mechanism 1720 towards it engaged condition, the connector 1719 may be able to instantaneously retain the load applying member relative to the second structural member, without the non-return mechanism having to move to its closest indexed location.

Because the connector 1719 may be biased towards its engaged condition, and not have to translate to its closest indexed position in order to reach its engaged condition, reduced movement of the first structural member 1700 may be allowed under its forcing in the second direction 1704. This may allow increased energy to be absorbed due to crushing of the crushable portion. Additionally, as the connector may be biased towards its engaged condition high impulses on the non-return mechanism components may be reduced or prevented as the components do not jumps to their closest indexed position before being retained relative to each other.

The connector 1719 may have advantages in its simplicity and required manufacturing tolerances over prior art connectors and potentially also the connector of FIGS. 4 to 16.

While the described operational direction of the connector 1719 when assembled with a first and second structural members has involved a crushing and absorption of energy during a movement of the first and second structural members away from each other, it is contemplated that the connector could also be applied to absorb energy during a movement of the structural components or of two structural components towards each other. Such a configuration may have the wedges 1726 and wedging surface 1724 converge together in the second direction 1706 rather than in the first direction 1704.

The foregoing description of the invention includes preferred forms thereof. Modifications may be made thereto without departing from the scope of the invention.

1. A connector for connecting between a first and second structural members, the connector comprising:
a load applying member which bears in use in a first direction against a crushable portion of the first structural member,
a retainer which retains the load applying member at an initial distance from the second structural member, and
a non-return mechanism which acts in successive cycles of forced movement of the first structural member, such that when the first structural member is forcibly moved in a direction opposite the first direction the load applying member progressively crushes the crushable portion of the first structural member, and when the first structural member is then moved in the first direction the retained location of the load applying member is moved in the first direction relative to the second structural member.

2. The connector as claimed in claim 1, wherein the progressive crushing of the crushable portion of the first structural member occurs during its forced movement in a direction opposite the first direction due to a retention of the load applying member relative to the second structural member.

3. The connector as claimed in claim 2, wherein the retention of the load applying member relative to the second structural member is provided by the non-return mechanism when in an engaged condition.

4. The connector as claimed in claim 1, wherein the non-return mechanism allows progressive movement of the first apparatus member in a direction opposite the first direction relative to the second apparatus member during cycles of forced movement of the first apparatus member.

5. The connector as claimed in claim 1 wherein the non-return mechanism is configured to prevent a motion of the load applying member in a direction opposite the first direction, yet allow at least some motion of the load applying member in the first direction under cycles of movement of the first structural member.

6. The connector as claimed in claim 1, wherein
the crushing of the crushable portion of the first structural member occurs when the first structural member is forcibly moved in a direction opposite the first direction and the non-return mechanism is in an engaged condition, and
wherein the movement of the retained location of the load applying member in the first direction relative to the second structural member occurs when the non-return mechanism is in a disengaged condition.

7. The connector as claimed in claim 6, wherein in the engaged condition of the non-return mechanism the load applying member is prevented from movement in the direction opposite the first direction relative to the second structural member.

8. The connector as claimed in claim 6, wherein the engaged condition of the non-return mechanism a binding association exists between the load applying member and the second structural member.

9. The connector as claimed in claim 6, wherein an operation of the non-return mechanism into its engaged condition is caused by a forced movement of the first structural member in the direction opposite the first direction.

10. The connector as claimed in claim 6, wherein the non-return mechanism comprises a bias to urge the non-return mechanism its engaged condition.

11. The connector as claimed in claim 10, wherein the bias is by a spring.

12. The connector as claimed in claim 6 wherein there is a biasing of the load applying member in the first direction on the crushable portion of the first structural member.

13.-19. (canceled)

20. The connector as claimed in claim 6, wherein the engagement of the non-return mechanism is by way of a frictional engagement of at least one frictional engagement member.

21.-41. (canceled)

42. A method of servicing of a connector of claims 6 when installed as part of a structure following one or more cycles of movement of the first and second structural members in the first direction and second direction relative to each other, the cycles of movement resulting in the progressive crushing of at least some of the crushable portion of the first structural member, the method comprising the steps of:
a) associating a disengagement element with the non-return mechanism to cause it to become disengaged,
b) moving the load applying member in the second direction to move it away from the crushable portion of the first structural member,
c) removing at least a crushed part of the crushable portion of the first structural member and replacing it with an un-crushed portion, and
d) removing from association with the non-return mechanism the disengagement element and returning the load applying member to bear in the first direction against the crushable portion of the first structural member.

43.-64. (canceled)

65. A connector to connect a first structural member and second structural member of or for a building or structure the connector comprising:
a first connector member associated with the first structural member and comprising a lateral that bears on a surface of said first structural member in a first direction (eg preferably is passes into a hole in the first structural member) and
a second connector member part of or engaged to the second structural member and
a non-return engagement between the first and second connector members, to prevent relative motion between the first and second connector members in a second direction that is opposite said first direction and allow movement in a first direction,
a) such that a displacement of the first structural member in the second direction results in a deformation of the lateral and/or crushing of the first structural member beneath the lateral, and
b) a displacement of the first structural member in the first direction results in a ratcheting of the first and second connector members relative to each other.

66. (canceled)

67. A method of providing an anchoring or tying interaction between structural members which comprises at least a non-return progressive engagement to reduce separation responsive to external input that otherwise reciprocates the structural to cause them to separate.

68.-91. (canceled)

92. A connector to connect a first structural member with second structural member of or for a building or structure, the connector comprising:
a first connector member of or engaged to the first structural member and
a second connector member carried by the second structural member and comprising a lateral that bears against a surface of said second structural member in a first direction (eg by passing into a hole in the second structural member),
wherein one of the first connector member and second connector member has an array of teeth and the other of the first connector member and second connector member has a pawl the pawl and teeth configured to define a ratchet between the first and second connector members, to
(A) prevent under the influence of a force acting to separate the first structural member and the second structural member in a second direction (being opposite said first direction) the separation between the first and second structural members save for any such separation resulting from the force induced deformation of at least one of:
a. the lateral (e.g. yielding), and
b. the material of the second structural member at where said lateral bears on said second structural member, caused by the lateral (e.g. crushing)
(B) allow ratcheting movement between the first and second structural members in a first direction subsequent deformation.

93. The connector as claimed in claim 92 wherein said deformation is of the material of said second structural member.

94. The connector as claimed in claim 92 wherein said deformation is of the material of said second structural member and of the lateral.

95.-98. (canceled)

99. In a structure,
a first structural member,
a second structural member to bear at least some of the mass or weight of or carried by the first structural member, whether as a foundation or other, the first structural member resting directly or indirectly against or on the second structural member, and
a retainer comprising an inter-engaged first retainer portion acting on an external surface or internal surface, or both, of the second structural member, and a second retainer portion fixed to, or fixed relative to, or both, the first structural member;
wherein the inter-engagement of the first retainer portion and second retainer portion
a) allows movement of the first structural member towards the second structural member, and
b) prevents the motion of the first structural member away from the second structural member without resulting in a plastic deformation of the material of the first structural member.

100.-108. (canceled)
